(19) United States
(12) Patent Application Publication
(10) Pub. No.: US 2026/0164522 A1
(43) Pub. Date: Jun. 11, 2026

(54) CONTROL SYSTEM FOR SWITCHING CONVERTER

(71) Applicant: Renesas Design (UK) Limited, Bourne End (GB)

(72) Inventors: Chang Yu WU, Tainan (TW); Yong Xiong LIN, Union City, CA (US); Guang FENG, Cupertino, CA (US)

(73) Assignee: Renesas Design (UK) Limited, Bourne End (GB)

(21) Appl. No.: 18/971,315

(22) Filed: Dec. 6, 2024

(51) Int. Cl. H05B 45/345; H05B 45/36; H05B 45/375; H05B 45/38

(52) U.S. Cl. CPC H05B 45/345; H05B 45/36; H05B 45/375; H05B 45/38

(57) ABSTRACT

A control system for a switching converter for receiving an input voltage and generating an output voltage, the switching converter including a first switch configured to be switchable between a first state and a second state, a sense device, and an energy storage element, wherein the control system is configured to receive a sense device voltage from the sense device, and provide a control signal to control the first switch to switch the first switch from the first state to the second state based on the sense device voltage as detected whilst the first switch is in the first state, and switch the first switch from the second state to the first state based on the sense device voltage as detected whilst the first switch is in the first state.

The present disclosure relates to a control system for a switching converter.

### BACKGROUND

FIG. 1A is a schematic of a known switching converter 100. During operation, the current flowing through inductor L is equal to the current flowing through the sensing resistor RISNS. The inductor current regulation can be achieved by regulating the voltage across RISNS.

While most load devices require a constant voltage source, there are many applications that require a regulated current source. Battery charging is one application that requires a constant current source. Another large application is LED lighting, as the light output of LED devices is variable based on forward current.

FIG. 1A shows the switching converter 100 for providing a constant current source to an LED device 102. Although FIG. 1A shows a single LED device, it is common to have many LED devices in series, all driven by the same regulated current source.

The topology shown in FIG. 1A is commonly used in LED lighting applications and the control method to regulate the output current is very simple. For example, a known control method uses two comparators: one set at a high current threshold; and the other set at a low current threshold. Once the voltage VISNS, being the voltage across the sense resistor RISNS reaches the HIGH threshold, the switch SW1 is turned OFF and once the VISNS reaches the LOW threshold, the switch SW1 is turned ON.

FIG. 1B is a timing graph 104 showing waveforms related to a practical implementation of the switching converter 100. The following waveforms are shown:
IL is the inductor current.

IL_Ton is the inductor current during SW1 turned on.

IL_Toff is the inductor current during SW1 turned off
Ton is the turned-on time of MOSFET SW1.
Toff is the turned-off time of MOSFET SW1.
Toff_mid is the middle of the off time of MOSFET SW1
VISNS is the voltage across the resistor RISNS

### SUMMARY

It is desirable to provide an improved control system for a power converter.

According to a first aspect of the disclosure there is provided a control system for a switching converter for receiving an input voltage and generating an output voltage, the switching converter comprising a first switch configured to be switchable between a first state and a second state, a sense device, and an energy storage element, wherein the control system is configured to receive a sense device voltage from the sense device, and provide a control signal to control the first switch to switch the first switch from the first state to the second state based on the sense device voltage as detected whilst the first switch is in the first state, and switch the first switch from the second state to the first state based on the sense device voltage as detected whilst the first switch is in the first state.

Optionally, the sense device comprises a sense resistive element.

Optionally, the control system is configured to detect the sense device voltage across the sense resistive element, thereby receiving the sense device voltage from the sense device.

Optionally, the switching converter comprises a first pass device coupled to the first switch at a switching node, wherein the sense resistive element is coupled in series with the first switch and the first pass device, and the energy storage element is coupled to the switching node.

Optionally, the first switch comprises a first metal oxide semiconductor field effect transistor (MOSFET) or a bipolar junction transistor (BJT).

Optionally, the first pass device comprises a second switch or a first diode.

Optionally, the second switch comprises a first metal oxide semiconductor field effect transistor (MOSFET) or a bipolar junction transistor (BJT).

Optionally, the energy storage element comprises an inductor.

Optionally, the switching converter is a buck converter, a boost converter, a buck-boost converter, or a Totem-Pole PFC boost converter.

Optionally, the first state is an on state and the second state is an off state, or the first state is the off state and the second state is the on state.

Optionally, the control system comprises a control signal generator configured to generate the control signal.

Optionally, the control system comprises a first comparator configured to receive the sense device voltage during the first state, and compare the sense device voltage with a first reference voltage, wherein the control signal generator is configured to generate the control signal to switch the first switch from the first state to the second state based on the comparison of the sense device voltage with the first reference voltage.

Optionally, the control signal generator is configured to generate the control signal to switch the first switch from the second state to the first state when a second state duration is approximately equal to a first threshold duration, the first threshold duration being dependent on the sense device voltage during the first state.

Optionally, the control system comprises a ramp generator configured to generate a ramp voltage signal that increases whilst the first switch is in the second state, a second comparator configured to receive the ramp voltage signal, the ramp voltage signal being indicative of the second state duration, receive a first threshold duration signal that is dependent on the sense device voltage during the first state, and is indicative of the first threshold duration, and compare the ramp voltage signal with the first threshold duration signal, wherein the control signal generator is configured to generate the control signal to switch the first switch from the second state to the first state when the ramp voltage signal is approximately equal to the first threshold duration signal, thereby generating the control signal to switch the first switch from the second state to the first state when the second state duration is approximately equal to the first threshold duration.

Optionally, the control system comprises a compensator circuit configured to receive a first voltage measurement of the sense device voltage as measured at a first time step during the first state, compare the first voltage measurement with a first threshold voltage, and generate the first threshold duration signal based on the comparison between the first voltage measurement and the first threshold voltage.

Optionally, the control system comprises a sample and hold circuit configured to receive the sense device voltage, receive a first time step signal that is dependent on the first time step, and provide the first voltage measurement as acquired by measuring the sense device voltage at the first time step.

Optionally, the control system comprises a time determination unit configured to receive a second state timing signal that is in a low state when the first switch is in the first state and is in a high state when the first switch is in the second state, and generate the first time step signal using the second state timing signal.

Optionally, the first time step is at a mid point between the beginning and end of a first state duration, the first state duration being the time over which the first switch is in the first state, or the first time step is within the first 0% to 10% of the first state duration.

Optionally, the control system comprises a calculation unit configured to receive a first voltage measurement of the sense device voltage as measured at a first time step during the first state, and calculate a second voltage measurement using the first voltage measurement and a first calculation voltage, and a compensator circuit configured to receive the second voltage measurement, compare the second voltage measurement with a first threshold voltage, and generate the first threshold duration signal based on the comparison between the second voltage measurement and the first threshold voltage.

Optionally, the control system comprises a sample and hold circuit configured to receive the sense device voltage, receive a first time step signal that is dependent on the first time step, and provide the first voltage measurement as acquired by measuring the sense device voltage at the first time step.

Optionally, the control system comprises a time determination unit configured to receive a second state timing signal that is in a low state when the first switch is in the first state and is in a high state when the first switch is in the second state, and generate the first time step signal using the second state timing signal.

Optionally, the control system comprises a compensator circuit configured to receive a first time period signal comprising information on a first time period from a time at which the first switch transitions to the first state until the sense device voltage is approximately equal to a second threshold voltage, and receive a second time period signal comprising information on a second time period from a time at which the sense device voltage is approximately equal to the second threshold voltage to a time at which the first switch transitions from the first state.

Optionally, the control system comprises a comparator and timing control circuit configured to receive the sense device voltage, receive the second threshold voltage, receive a first state timing signal that is in a high state when the first switch is in the first state and is in a low state when the first switch is in the second state, generate the first time period signal and the second time period signal using the sense device voltage, the first threshold voltage and the first state timing signal.

Optionally, the first comparator is configured to provide a first comparator output that is dependent on the comparison between sense device voltage and the first reference voltage, the second comparator is configured to provide a second comparator output that is dependent on the comparison between the ramp voltage signal and the first threshold duration signal, the control system comprises a latch circuit configured to receive the first comparator output at a set terminal, receive the second comparator output at a reset terminal, provide a second state timing signal that is in a low state when the first switch is in the first state and is in a high state when the first switch is in the second state, at a non-inverting output, and provide a first state timing signal that is in a high state when the first switch is in the first state and is in a low state when the first switch is in the second state, at an inverting input, the control signal generator is configured to receive one or both of the first and second state timing signals, and generate the control signal using one or both of the first and second state timing signals.

According to a second aspect of the disclosure there is provided an apparatus comprising a control system and a switching converter for receiving an input voltage and generating an output voltage, the switching converter comprising a first switch configured to be switchable between a first state and a second state, a sense device, and an energy storage element, wherein the control system is configured to receive a sense device voltage from the sense device, and provide a control signal to control the first switch to switch the first switch from the first state to the second state based on the sense device voltage as detected whilst the first switch is in the first state, and switch the first switch from the second state to the first state based on the sense device voltage as detected whilst the first switch is in the first state.

It will be appreciated that the apparatus of the second aspect may include features set out in relation to the first aspect and/or may include other features as described herein.

According to a third aspect of the disclosure there is provided a method of controlling a switching converter for receiving an input voltage and generating an output voltage using a control system, the switching converter comprising a first switch configured to be switchable between a first state and a second state, a sense device, and an energy storage element, wherein the method comprises receiving, using the control system a sense device voltage from the sense device, and providing, from the control system, a control signal to control the first switch to switch the first switch from the first state to the second state based on the sense device voltage as detected whilst the first switch is in the first state, and switch the first switch from the second state to the first state based on the sense device voltage as detected whilst the first switch is in the first state.

It will be appreciated that the method of the third aspect may include using and/providing features set out in relation to the first and/or second aspects and can incorporate other features as described herein.

### BRIEF DESCRIPTION OF THE DRAWINGS

The disclosure is described in further detail below by way of example and with reference to the accompanying drawings, in which:

FIG. 1A is a schematic of a known switching converter, FIG. 1B is a timing graph showing waveforms related to a practical implementation of the switching converter of FIG. 1A;

FIG. 2A is a schematic of a further switching converter, FIG. 2B is a timing graph showing waveforms related to a practical implementation of the switching converter of FIG. 2A, FIG. 2C is a schematic of a further switching converter, FIG. 2D is a timing graph showing waveforms related to a practical implementation of the switching converter of FIG. 2C;

FIG. 3A is a schematic of a control system and a switching converter in accordance with a first embodiment of the present disclosure, FIG. 3B is a timing graph showing waveforms related to a practical implementation of the switching converter of FIG. 3A, FIG. 3C is a timing graph showing waveforms related to a practical implementation of the switching converter of FIG. 3A;

FIG. 4A is a schematic of a specific embodiment of the control system and the switching converter, in accordance with a second embodiment of the present disclosure, FIG. 4B is a schematic of a further specific embodiment of the control system and the switching converter, in accordance with a third embodiment of the present disclosure;

FIG. 5A is a graph showing the relationship between voltages for a practical implementation of the switching converter of FIG. 2A, FIG. 5B is a further graph showing the relationship between voltages for a practical implementation of the switching converter of FIG. 2A;

FIG. 6A is a schematic of a specific implementation of the control system that may be implemented with the switching converter of FIG. 2A in accordance with a fourth embodiment of the present disclosure, FIG. 6B is a timing graph showing waveforms related to a practical implementation of the control system of FIG. 6A, FIG. 6C is a flow chart illustrating the operation of the switch of the present embodiment, FIG. 6D is a flow chart showing the regulation of the sense resistor voltage in the present embodiment, FIG. 6E is a schematic of a specific embodiment of the switching converter as may be used with the control system of FIG. 6A, FIG. 6F shows simulation results for a practical implementation of the control system of FIG. 6A and the switching converter of FIG. 6E;

FIG. 7A is a graph showing the relationship between voltages for a further practical implementation of the switching converter of FIG. 2A, FIG. 7B is a further graph showing the relationship between voltages for the further practical implementation of the switching converter of FIG. 2A;

FIG. 8A is a schematic of a specific implementation of the control system that may be implemented with the switching converter of FIG. 2A in accordance with a fifth embodiment of the present disclosure, FIG. 8B is a timing graph showing waveforms related to a practical implementation of the control system of FIG. 8A, FIG. 8C is a flow chart illustrating the operation of the switch of the present embodiment;

FIG. 9A is a schematic of a specific implementation of the control system that may be implemented with the switching converter of FIG. 2A in accordance with a sixth embodiment of the present disclosure, FIG. 9B is a timing graph showing waveforms related to a practical implementation of the control system of FIG. 9A, FIG. 9C is a flow chart illustrating the operation of the switch of the present embodiment;

FIG. 10A is a schematic of a specific implementation of the control system that may be implemented with the switching converter of FIG. 2A in accordance with a seventh embodiment of the present disclosure, FIG. 10B is a timing graph showing waveforms related to a practical implementation of the control system of FIG. 10A, FIG. 10C is a flow chart illustrating the operation of the switch of the present embodiment;

FIG. 11 is a timing graph showing the relationship between voltages for a practical implementation of the switching converter of FIG. 2C;

FIG. 12A is a schematic of a specific implementation of the control system that may be implemented with the switching converter of FIG. 2C in accordance with an eighth embodiment of the present disclosure, FIG. 12B is a timing graph showing waveforms related to a practical implementation of the control system of FIG. 12A, FIG. 12C is a flow chart illustrating the operation of the switch of the present embodiment, FIG. 12D is a flow chart showing the regulation of the sense resistor voltage in the present embodiment;

FIG. 13A is a schematic of a specific implementation of the control system that may be implemented with the switching converter of FIG. 2C in accordance with a ninth embodiment of the present disclosure, FIG. 13B is a timing graph showing waveforms related to a practical implementation of the control system of FIG. 13A, FIG. 13C is a flow chart showing the regulation of the sense resistor voltage in the present embodiment;

FIG. 14A is a schematic of a specific implementation of the control system that may be implemented with the switching converter of FIG. 2C in accordance with a tenth embodiment of the present disclosure, FIG. 14B is a timing graph showing waveforms related to a practical implementation of the control system of FIG. 14A, FIG. 14C is a flow chart showing the regulation of the sense resistor voltage in the present embodiment;

FIG. 15 is a timing graph showing the relationship between voltages for a practical implementation of the switching converter of FIG. 2C; and

FIG. 16A is a schematic of a specific implementation of the control system that may be implemented with the switching converter of FIG. 2C in accordance with an eleventh embodiment of the present disclosure, FIG. 16B is a timing graph showing waveforms related to a practical implementation of the control system of FIG. 16A, FIG. 16C is a flow chart showing the regulation of the sense resistor voltage in the present embodiment.

### DETAILED DESCRIPTION

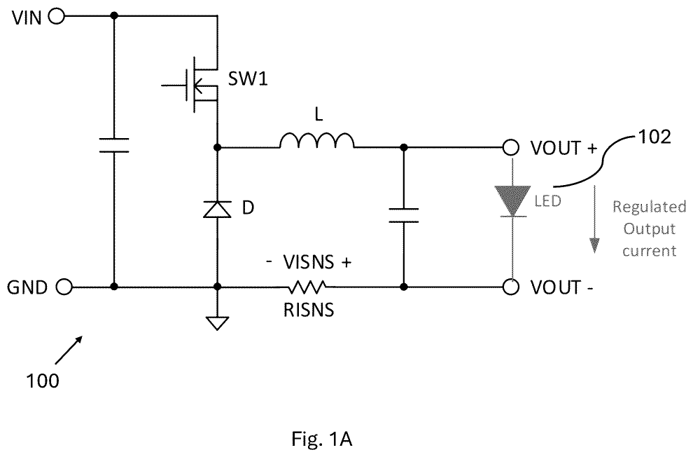

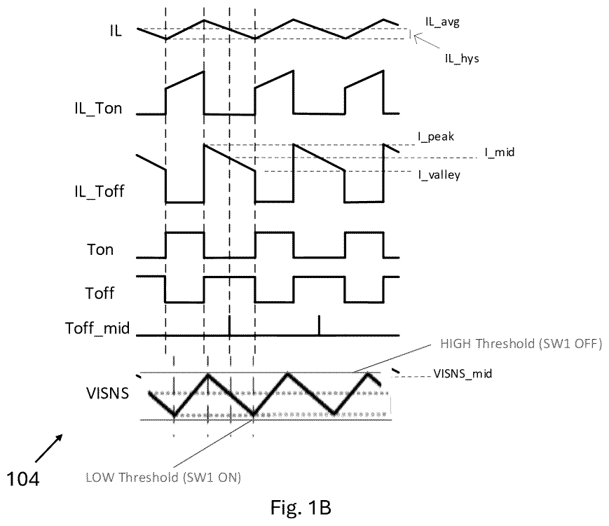

The switching converter 100, as shown in FIG. 1A, uses a simple control method. However, the control method has several drawbacks. For example, since the sense resistor RISNS is either in series with the output terminal or in series with the return path, it causes a lot of IR power dissipation. Also, placing the sense resistor RISNS in the return path allows for a simpler IC integration implementation, but it creates a separation between the return path and the ground connection GND.

Embodiments of the present disclosure provide a new topology and a new control method overcoming the limitations of the known systems. In a specific embodiment the sense resister RISNS is removed from the high current path (in series with the output or return terminal, thereby removing the dissipative IR losses.

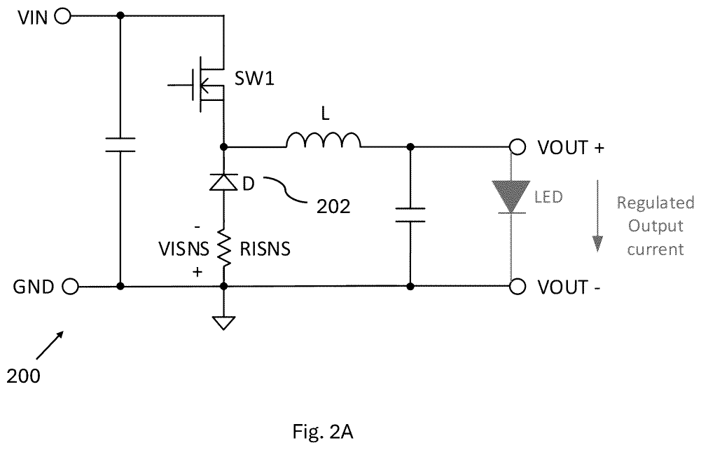

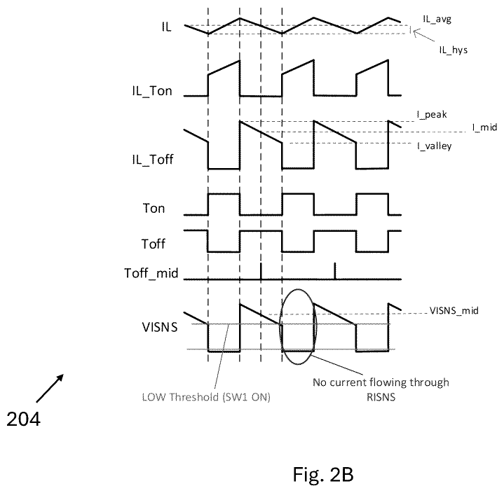

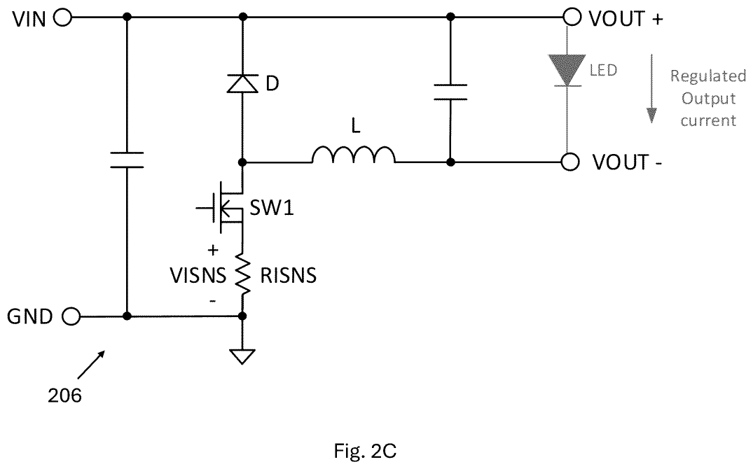

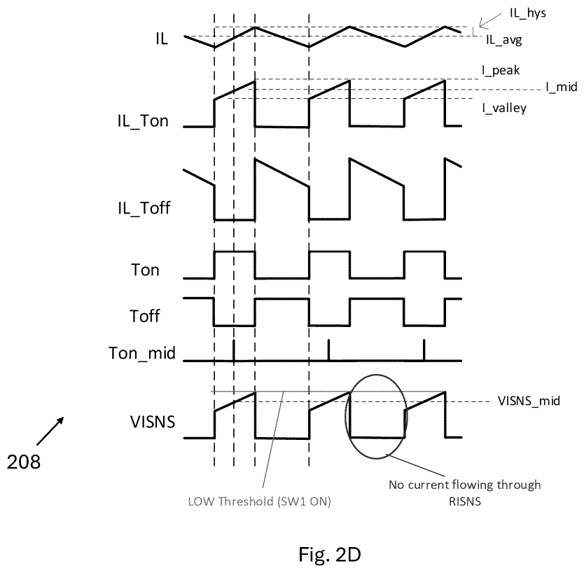

FIG. 2A is a schematic of a switching converter 200. Compared to the switching converter 100, the sense resistor RISNS is now in series with the switch SW1 and a pass device 202. In the present example, the pass device 202 is a diode D. Alternatively, the pass device 202 may be a metal oxide semiconductor field effect transistor (MOSFET). In the present example the switching converter 200 is a buck converter. The control method of the present disclosure may be applied to the switching converter 200, as described below.

FIG. 2B is a timing graph 204 showing waveforms related to a practical implementation of the switching converter 200. The following waveforms and features are shown:
IL is the inductor current.
IL_Ton is the inductor current during SW1 turned on.
IL_Toff is the inductor current during SW1 turned off.
Ton is the turned-on time of MOSFET SW1.
Toff is the turned-off time of MOSFET SW1.
Toff_mid is the middle of the off time of MOSFET SW1.
VISNS is the voltage across the resistor RISNS.
IL_avg is the average of the inductor current.
IL_hys is the inductor ripple current.
I_mid is the IL_Toff at Toff_mid.
I_peak is the peak of the IL_Toff during Toff.
I_valley is the valley of the IL_Toff during Toff.
VISNS_mid is the sampled and held voltage VISNS at Toff_mid.

As shown by the VISNS waveform in FIG. 2B, the current through the sense resistor RISNS while SW1 is in the OFF state is 0A. Therefore, the simple control method of using two voltage thresholds to turn ON and OFF the switch SW1 used for the switching converter 100 cannot be used with the present topology. In the present example, the sense resistor RISNS can only detect the inductor current during the period when the switch SW1 is turned off.

As shown by the VISNS waveform, the discharge of the current through the inductor L can be clearly detected and the LOW threshold can be used to determine when the switch SW1 should be turned ON. However, when the switch SW1 is turned on, there is no current through the sense resistor RISNS and therefore, it cannot directly be determined when to turn on SW1 through the sense resistor voltage VISNS.

Main factors relating to the control method of the present disclosure in relation to the topography presented in FIG. 2A may be summarised as follows:
When to turn on the switch SW1: It may be determined by comparing the voltage VISNS and the low threshold.
When to turn off the switch SW1: It may be determined by the feedback loop for regulating the average inductor current.

In this way, the valley current can be limited by determining the timing point for turning on the switch SW1, and the average current can be regulated by determining the timing point for turning off the switch SW1.

When the inductor L operates in CCM (Continuous Conduction Mode), the average inductor current is equal to the average current during the switch SW1 on period, and it is also equal to the average current during the switch SW1 off period. Thus, the average inductor current can be regulated by modulating the average voltage VISNS during the Toff high state (when the switch SW1 is off) in FIG. 2B.

FIG. 2C is a schematic of a switching converter 206. In the present example the switching converter 206 is a buck converter. The control method of the present disclosure may be applied to the switching converter 206, as described below.

FIG. 2D is a timing graph 208 showing waveforms related to a practical implementation of the switching converter 206. The following waveforms and features are shown:
Ton_mid is the middle of the on time of MOSFET SW1.
I_mid is the IL_Ton at Ton_mid.
I_peak is the peak of the IL_Ton during Ton.
I_valley is the valley of the IL_Ton during Ton.
VISNS_mid is the sampled and held voltage VISNS at Ton_mid.

Similar to the topology shown in FIG. 2A and the associated waveforms in FIG. 2B, in the present example, the voltage VISNS only provides half of the required information.

In the case of FIG. 2A, the information to turn ON the switch SW1 may be derived from VISNS, but the information to turn OFF switch SW1 cannot be provided by the present value of VISNS. In the case of the switching converter 206 in FIG. 2C, information to turn OFF switch SW1 may be derived from VISNS, but the information to turn ON SW1 cannot be provided by the present value VISNS.

Main factors relating to the control method of the present disclosure in relation to the topography presented in FIG. 2C may be summarised as follows:
When to turn off the switch SW1: It may be determined by comparing VISNS and the high threshold.
When to turn on the switch SW1: It may be determined by the feedback loop for regulating the average inductor current.

In this way, the peak current can be limited by determining the timing point for turning off the switch SW1, and the average current can be regulated by determining the timing point for turning on the switch SW1.

When the inductor operates in CCM (Continuous Conduction Mode), the average inductor current is equal to the average current during the switch SW1 on period, and it is also equal to the average current during the switch SW1 off period. Thus, the average inductor current can be regulated by modulating the average VISNS during the Ton high state (when the switch SW1 is on) in FIG. 2D.

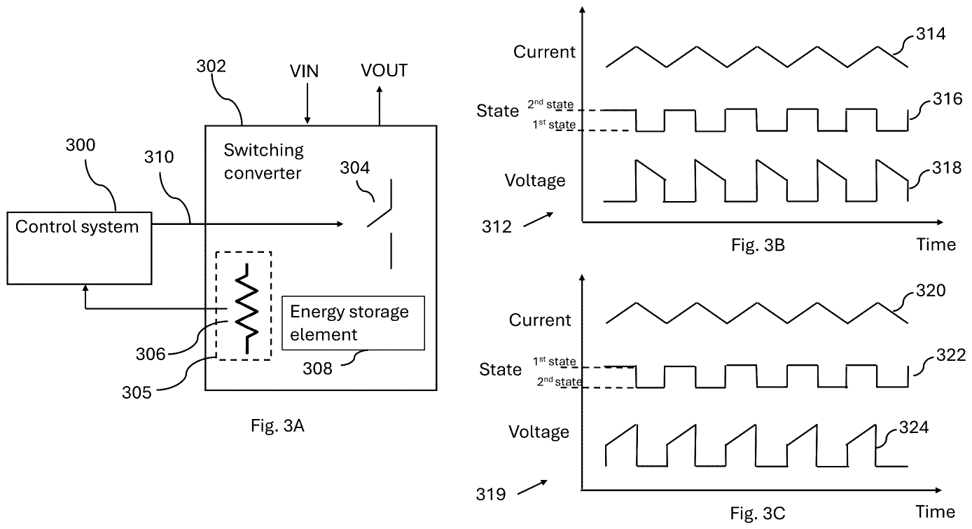

FIG. 3A is a schematic of a control system 300 and a switching converter 302 in accordance with a first embodiment of the present disclosure. During operation, the switching converter 302 receives an input voltage VIN and generates an output voltage VOUT. The switching converter 302 comprises a switch 304 configured to be switchable between a first state and a second state, a sense device 305, and an energy storage element 308.

The switching converter 302 may, for example, be a buck converter, a boost converter, a buck-boost converter, or a Totem-Pole PFC boost converter.

In a specific embodiment, the first state may be the on state, where the switch 304 is arranged to permit current flow, and the second state may be the off state, where the switch 304 is arranged to prevent current flow. In a further embodiment, the first state may be the off state and the second state may be the on state.

The switch 304 may, for example, comprise a transistor such as a MOSFET or a bipolar junction transistor (BJT). The energy storage element 308 may comprise an inductor.

The control system 300 is configured to receive a sense device voltage from the sense device 305, and provide a control signal 310 to control the switch 304 to:
switch the switch 304 from the first state to the second state based on the sense device voltage as detected whilst the switch 304 is in the first state, and
switch the switch 304 from the second state to the first state based on the sense device voltage as detected whilst the switch 304 is in the first state.

The sense device 305 is used for current detection. During operation, the sense device 305 generates the sense device voltage, which is dependent on a current flowing in the switching converter 302.

In embodiments described herein, the sense device 305 comprises a sense resistive element 306. It will be appreciated that the sense resistive element 306 may be implemented using any suitable resistive element that can be used for current detection. For example, the sense resistive element 306 may be a sense resistor, or may be implemented by a further switch, such as a MOSFET, with the resistance for current sensing being provide by the on-resistance of the MOSFET.

In embodiments described herein where the sense device 305 comprises the sense resistive element 306, the sense device voltage may be referred to as a sense resistor voltage VISNS.

In further embodiments, the sense device 305 may comprise a current transformer, a Hall sensor, or any other suitable type of current sensing device for generating the sense device voltage, in accordance with the understanding of the skilled person.

In the present embodiment, the control system 300 is configured to detect the sense resistor voltage VISNS across the sense resistive element 306, thereby receiving the sense device voltage from the sense device 305, and to provide a control signal 310 to control the switch 304 to:
switch the switch 304 from the first state to the second state based on the sense resistor voltage VISNS as detected whilst the switch 304 is in the first state, and
switch the switch 304 from the second state to the first state based on the sense resistor voltage VISNS as detected whilst the switch 304 is in the first state.

During operation, the control system 300 switches the switch 304 between the first and second states based on the sense resistor voltage VISNS during the same “first state”.

This contrasts with the known switching converter 100 where the sense resistor voltage VISNS during the on state is used to determine when to turn the switch SW1 to the off state and the sense resistor voltage VISNS during the off state is used to determine when to turn the switch SW1 to the on state. As described previously in relation to the switching converter topologies presented in FIG. 2A and FIG. 2B, the sense resistor voltage information is only available during one switch state of the switch SW1. Therefore, embodiments of the control system 300 of the present disclosure use the sense resistor voltage VISNS information during the same state to determine the turning on and turning off of the switch 304.

FIG. 3B is a timing graph 312 showing waveforms related to a practical implementation of the switching converter 302. The following waveforms and features are shown: a current through the energy storage element (a trace 314), a state of the switch 304 (a trace 316), and the sense resistor voltage VISNS (a trace 318).

A low signal of the state (the trace 316) may denote the switch 304 being in the first state (for example an off state) and a high signal of the state may denote the switch 304 being in the second state (for example an on state). The present example exhibits the same behaviour as shown by the waveforms of FIG. 2B for the switching converter 200 of FIG. 2A.

In the present example, the control system 300 is configured to detect the sense resistor voltage VISNS across the sense resistive element 306, and provide a control signal 310 to control the switch 304 to:

switch the switch 304 from the first state to the second state based on the sense resistor voltage VISNS as detected whilst the switch 304 is in the first state (when the state trace 316 is low), and
switch the switch 304 from the second state to the first state based on the sense resistor voltage VISNS as detected whilst the switch 304 is in the first state (when the state trace 316 is low).

FIG. 3C is a timing graph 319 showing waveforms related to a practical implementation of the switching converter 302. The following waveforms and features are shown: a current through the energy storage element (a trace 320), a state of the switch 304 (a trace 322), and the sense resistor voltage VISNS (a trace 324).

A high signal of the state (the trace 322) may denote the switch 304 being in the first state (for example an on state) and a low signal of the state may denote the switch 304 being in the second state (for example an off state). The present example exhibits the same behaviour as shown by the waveforms of FIG. 2D for the switching converter 206 of FIG. 2C.

In the present example, the control system 300 is configured to detect the sense resistor voltage VISNS across the sense resistive element 306, and provide a control signal 310 to control the switch 304 to:
switch the switch 304 from the first state to the second state based on the sense resistor voltage VISNS as detected whilst the switch 304 is in the first state (when the state trace 322 is high), and
switch the switch 304 from the second state to the first state based on the sense resistor voltage VISNS as detected whilst the switch 304 is in the first state (when the state trace 322 is high).

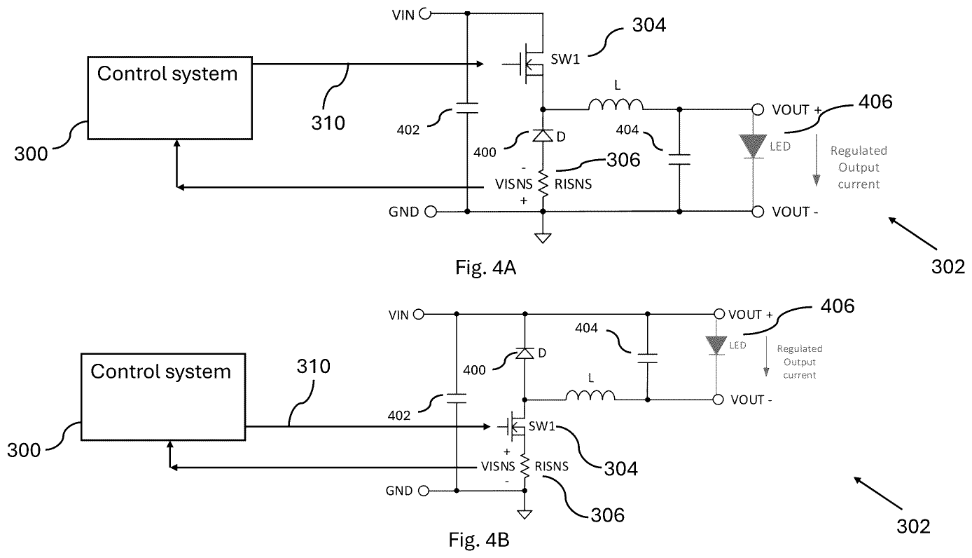

FIG. 4A is a schematic of a specific embodiment of the control system 300 and the switching converter 302, in accordance with a second embodiment of the present disclosure. In the present embodiment, the switching converter 302 is implemented as the switching converter 200 of FIG. 2A. The control system 300 can provide a regulated current output for the switching converter 302.

In the present embodiment, the switching converter 302 comprises a pass device 400 coupled to the switch 304 at a switching node N1. The sense resistive element 306 is coupled in series with the switch 304 and the pass device 400, and the energy storage element 308 is coupled to the switching node N1. In the present example, the pass device 400 comprises a diode D. In a further embodiment, the pass device 400 may comprise a second switch which may comprise a transistor such as a MOSFET. In the present example, the energy storage element 308 comprises an inductor L. The switching converter 302 further comprises capacitors 402, 404 and is coupled to an LED device 406.

It will be appreciated that in a further embodiment, the pass device 400 may function as the sense resistive element 306 thereby eliminating the requirement to have a distinct sense resistive element component. For example, in an embodiment where the pass device 400 is a second switch comprising a MOSFET, the on-resistance of the MOSFET may be used for current sensing, such that the pass device 400 can function as the sense resistive element 306.

FIG. 4B is a schematic of a further specific embodiment of the control system 300 and the switching converter 302, in accordance with a third embodiment of the present disclosure. In the present embodiment, the switching converter 302 is implemented as the switching converter 206 of FIG. 2C. The control system 300 can provide a regulated current output for the switching converter 302.

Returning to the switching converter 200 of FIG. 2A, the current sense resistor RISNS can detect IL_Toff so that:

$$VISNS = IL\_Toff \times RISNS \qquad ( 1 )$$

$$VISNS\_mid = I\_ mid \times RISNS \qquad ( 2 )$$

When the inductor L operates at CCM, I_mid is equal to the average inductor current IL_avg. Thus, the constant current regulation can be achieved by regulating I_mid, and it can be achieved by regulating VISNS_mid as well.

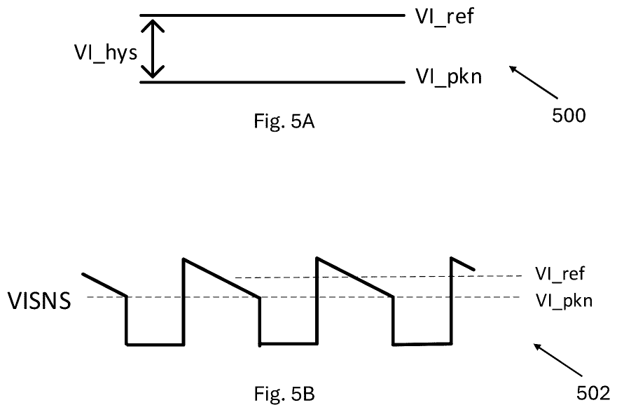

FIG. 5A is a graph 500 showing the relationship between voltages for a practical implementation of the switching converter 200 of FIG. 2A. There is shown:
VI_ref is the reference voltage of VISNS.
VI_hys is the hysteresis voltage of VISNS.
VI_pkn is the lower regulation limit.

The reference voltage VI_ref may be adjustable or may be fixed. The hysteresis voltage VI_hys may be adjustable or may be fixed.

It will be appreciated that for further embodiments, the reference voltage VI_ref and/or the hysteresis voltage VI_hys are not limited to a stable voltage level. For example, the reference voltage VI_ref and/or the hysteresis voltage VI_hys can be a half-sine, triangle, or any other type of voltage.

It will be appreciated that for further embodiments, the lower regulation limit VI_pkn is not limited to a stable voltage level. For example, the lower regulation limit VI_pkn can be a half-sine, triangle, or any other type of voltage.

FIG. 5B is a further graph 502 showing the relationship between voltages for a practical implementation of the switching converter 200 of FIG. 2A.

The voltages are related as follows:

$$VI\_pkn = VI\_ref - VI\_hys \qquad ( 3 )$$

By controlling the valley of VISNS to VI_pkn, the inductor ripple current can be regulated to:

$$IL\_hys = VI\_hys / RISNS \qquad ( 4 )$$

Equation (4) can be achieved by the operation: when VISNS<VI_pkn, turn on the switch SW1.

By regulating VISNS_mid to VI_ref, the average inductor current can be regulated to:

$$IL\_avg = VI\_ref / RISNS \qquad ( 5 )$$

Equation (5) may be achieved by modulating the on time Ton of the switch SW1.

The regulation can be achieved by various implementations, and it will generate a control operation based on Ton and a threshold duration Ton_VC. In a specific embodiment, there may be a counter to implement this functionality. The counter may be a digital or an analog counter. Counting may begin from the timing of the switch SW1 turning on and may continue until the switch SW1 is turned off at Ton_VC. With this control, Ton is equal to Ton_VC.

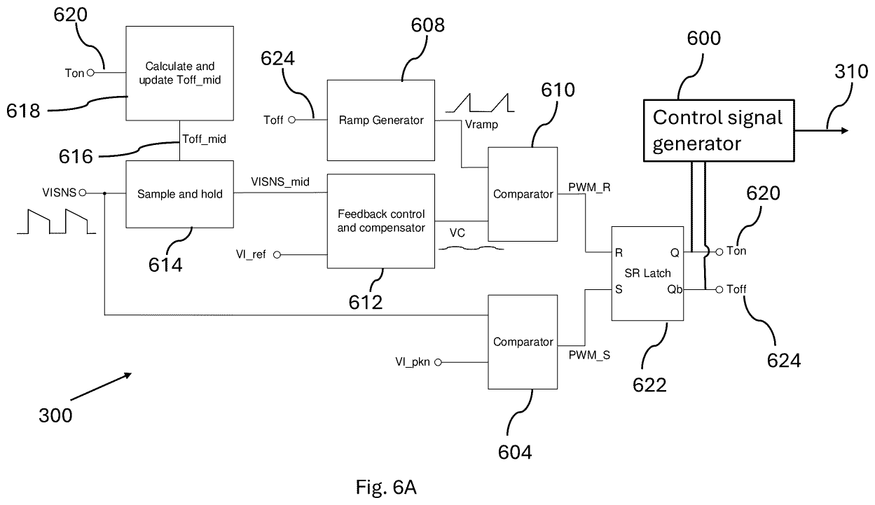

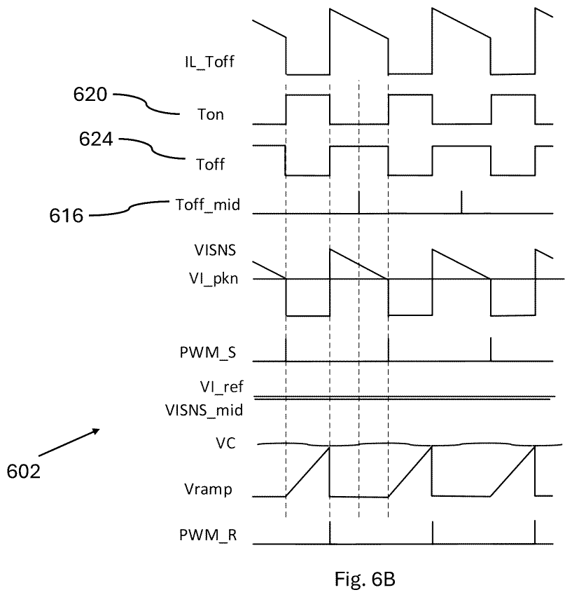

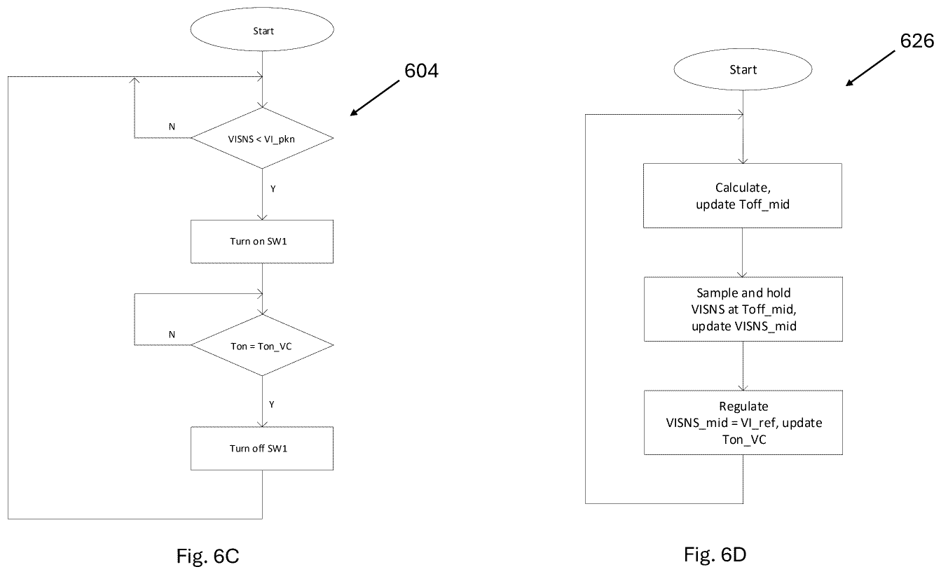

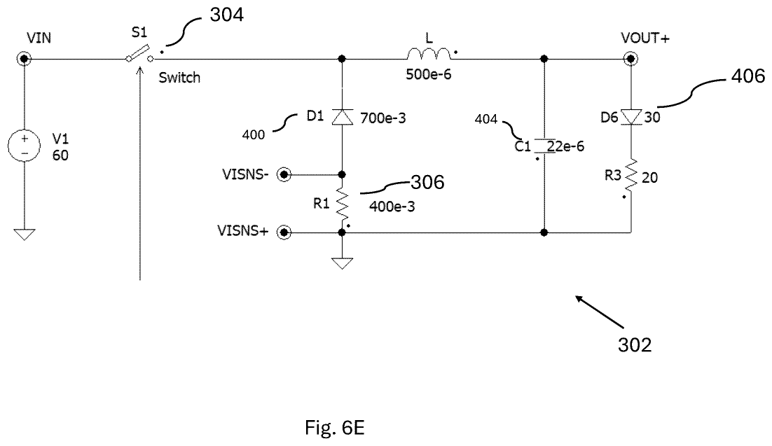

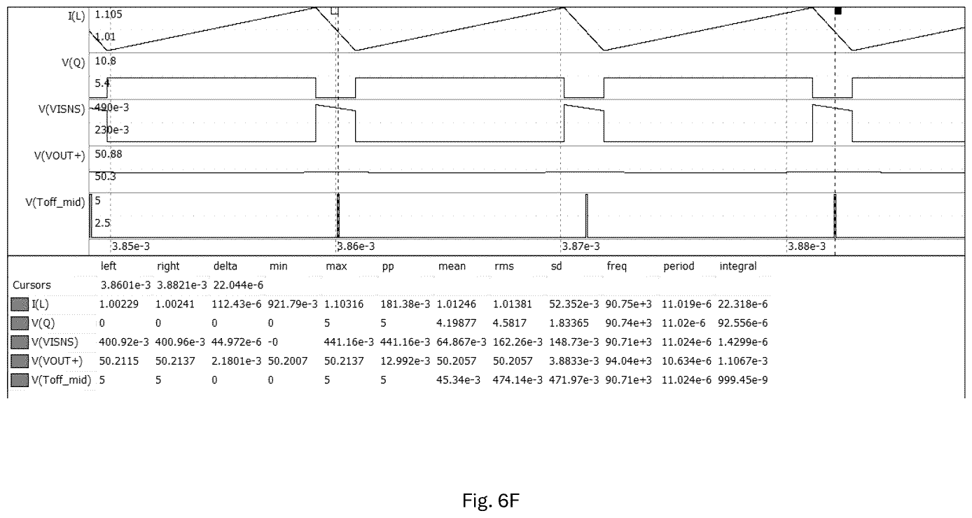

FIG. 6A is a schematic of a specific implementation of the control system 300 that may be implemented with the switching converter 200 of FIG. 2A in accordance with a fourth embodiment of the present disclosure. For example the control system 300 of the present embodiment may be a specific implementation of the control system 300 of FIG. 4A.

The control system 300 may comprise a control signal generator 600 configured to generate the control signal 310.

FIG. 6B is a timing graph 602 showing waveforms related to a practical implementation of the control system 300 of FIG. 6A. The waveforms shown in the graph 602 are as described previously for FIG. 2B with additional waveforms being as shown in FIG. 6A.

The control system 300 may comprise a comparator 604 configured to receive the sense resistor voltage VISNS whilst the switch 304 is in the off state, and compare the sense resistor voltage VISNS with a reference voltage VI_pkn. The control signal generator 600 is configured to generate the control signal 310 to switch the switch 304 from the off state to the on state based on the comparison between the sense resistor voltage VISNS and the reference voltage VI_pkn.

In specific embodiments, the comparator 604 may be implemented using an analog circuit or a digital circuit.

The turn-on timing is determined by the comparator 604 whose inputs are VISNS and VI_pkn. The turn on condition for the switch 304 may be summarised as: when VISNS<VI_pkn, turn on the switch 304.

The control signal generator 600 is configured to generate the control signal 310 to switch the switch 304 from the on state to the off state when the on state duration Ton is approximately equal to a threshold duration Ton_VC. The threshold duration Ton_VC is dependent on the sense resistor voltage VISNS during the off state. The operation may be summarised as: when Ton=Ton_VC, turn off switch 304.

FIG. 6C is a flow chart 606 illustrating the operation of the switch 304 of the present embodiment.

The control system 300 may comprise a ramp generator 608 configured to generate a ramp voltage signal Vramp that increases linearly whilst the switch 304 is in the on state. As the ramp voltage signal Vramp increases whilst the switch 304 is in the on state, the duration of time over which Vramp increases is indicative of the on time duration Ton.

In specific embodiments, the ramp generator 608 may be implemented using an analog circuit or a digital circuit. For example, the ramp generator 608 may be implemented using a digital counter.

The control system 300 may further comprise a comparator 610 configured to receive the ramp voltage signal Vramp and a threshold duration signal VC. The threshold duration signal is dependent on the sense resistor voltage VISNS during the off state, and is indicative of the threshold duration Ton_VC. The comparator 610 is configured to compare the ramp voltage signal Vramp and the threshold duration signal VC, which is used to determine when the on time duration Ton becomes equal to the threshold duration Ton_VC. The control signal generator 600 is configured to generate the control signal 310 to switch the switch 304 from the on state to the off state when the ramp voltage signal Vramp is approximately equal to the threshold duration signal VC.

In specific embodiments, the comparator 610 may be implemented using an analog circuit or a digital circuit.

The control system 300 may further comprise a compensator circuit 612 that is configured to receive a voltage measurement VISNS_mid of the sense resistor voltage VISINS as measured at a time step Toff_mid during the off state. VISNS_mid is the voltage acquired at the middle of the off state (as acquired at the time step Toff_mid) and is therefore representative of the average inductor current. The time step is at a mid point between the beginning and end of the state duration Toff, which is the duration of time over which the switch 304 is in the off state.

In specific embodiments, the compensator circuit 612 may be implemented using an analog circuit or a digital circuit.

The compensator circuit 612 is further configured to compare the voltage measurement VISNS_mid with a threshold voltage VI_ref. The compensator circuit 612 is further configured to generate the threshold duration signal VC based on the comparison between the voltage measurement VISNS_mid and the threshold voltage VI_ref. The turn-off timing is determined by the comparator 610 whose inputs are Vramp and VC, while VC is an error signal from VI_ref and VISNS_mid.

The control system 300 may further comprise a sample and hold circuit 614 configured to receive the sense resistor voltage VISNS, receive a time step signal 616 that is dependent on the time step Toff_mid and provide the voltage measurement VISNS_mid as acquired by measuring the sense resistor voltage VISNS at the time step Toff_mid.

The control system 300 may further comprise a time determination unit 618 configured to receive an on state timing signal 620 that is in a low state when the switch 304 is in the off state and is in a high state when the switch 304 is in the on state, for example as provided by Ton as shown in FIG. 6B. The time determination unit 618 may be further configured to generate the time step signal 616 using the on state timing signal 620.

The comparator 604 may provide an output PWM_S that is dependent on the comparison between the sense resistor voltage VISNS and the reference voltage VI_pkn. The comparator 610 may provide an output PWM_R that is dependent on the comparison between the ramp voltage signal Vramp and the threshold duration signal VC.

The control system 300 may further comprise a latch circuit 622 that is configured to receive the comparator output PWM_S at a set terminal S and the comparator output PWM_R at a reset terminal R. The latch circuit 622 is further configured to provide the on state timing signal 620 at a non-inverting output Q and an off state timing signal 624 at an inverting output Qb.

The control signal generator 600 may receive one or both of the timing signals 620, 624 and generate the control signal 310 using one or both the timing signals 620.

FIG. 6D is a flow chart 626 showing the regulation of the sense resistor voltage VISNS in the present embodiment. The process may be described as follows:
1. Calculate and update Toff_mid.
2. Sample and hold VISNS at Toff_mid, and update VISNS_mid.
3. Regulate VISNS_mid=VI_ref, and update Ton_VC.

FIG. 6E is a schematic of a specific embodiment of the switching converter 302 as may be used with the control system 300 of FIG. 6A. FIG. 6F shows simulation results for a practical implementation of the control system 300 of FIG. 6A and the switching converter 302 of FIG. 6E. The simulation parameters were as follows:
VIN=60V, and VOUT=50V
L=500 uH
Vref=400 mV, and Vhys=36 mV
RSNS=400 mohm
Regulation target: IL_avg=1A, and IL_hys=90 mA.

The simulation results shown in FIG. 6F indicate that IL_AVG=1.01A, and IL_hys=90.69 mA. The simulation results demonstrate that the control method of the present disclosure can regulate the inductor current.

In the above operation, Ton_VC is generated by regulating VISNS_mid=VI_ref. The inductor current regulation can also be achieved by regulating VISNS at different timings.

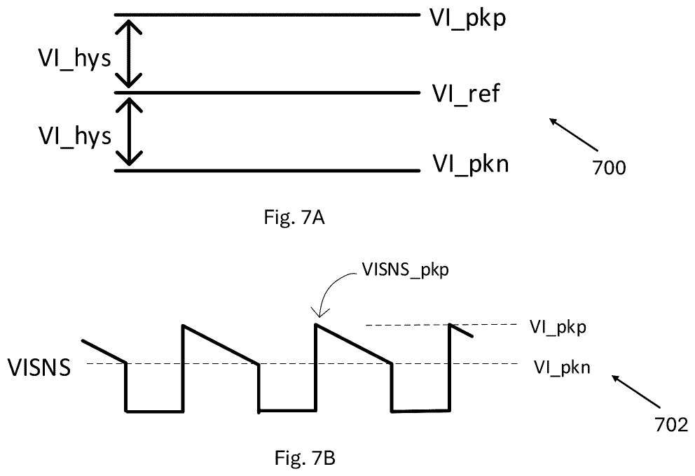

FIG. 7A is a graph 700 showing the relationship between voltages for a further practical implementation of the switching converter 200 of FIG. 2A. There is shown:
VI_ref is the reference voltage of VISNS.
VI_hys is the hysteresis voltage of VISNS.
VI_pkn is the lower regulation limit.
VI_pkp is the upper reference voltage of VISNS.

It will be appreciated that for specific embodiments, the upper reference voltage VI_pkp is not limited to a stable voltage level. For example, the upper reference voltage VI_pkp can be a half-sine, triangle, or any other type of voltage.

FIG. 7B is a further graph 702 showing the relationship between voltages for the further practical implementation of the switching converter 200 of FIG. 2A.

The voltages are related as follows:

$$VI\_pkp = VI\_ref + VI\_hys \qquad ( 6 )$$

VISN_pkp is the peak of the sense resistor voltage VISNS when the switch SW1 is in the off state.

By controlling the valley of VISNS to VI_pkn, the inductor ripple current can be regulated to:

$$IL\_hys = VI\_hys / RISNS \qquad ( 4 )$$

Equation (4) can be achieved by the operation: when VISNS<VI_pkn, turn on the switch SW1.

By regulating VISNS_pkp to VI_pkp, the average inductor current can be regulated to:

$$IL\_avg = VI\_ref / RISNS \qquad ( 5 )$$

Equation (5) may be achieved by modulating the on time Ton of the switch SW1.

The regulation can be achieved by various implementations, and it will generate a control operation based on Ton and a threshold duration Ton_VC. In a specific embodiment, there may be a counter to implement this functionality. The counter may be a digital or an analog counter. Counting may begin from the timing of the switch SW1 turning on and may continue until the switch SW1 is turned off at Ton_VC. With this control, Ton is equal to Ton_VC.

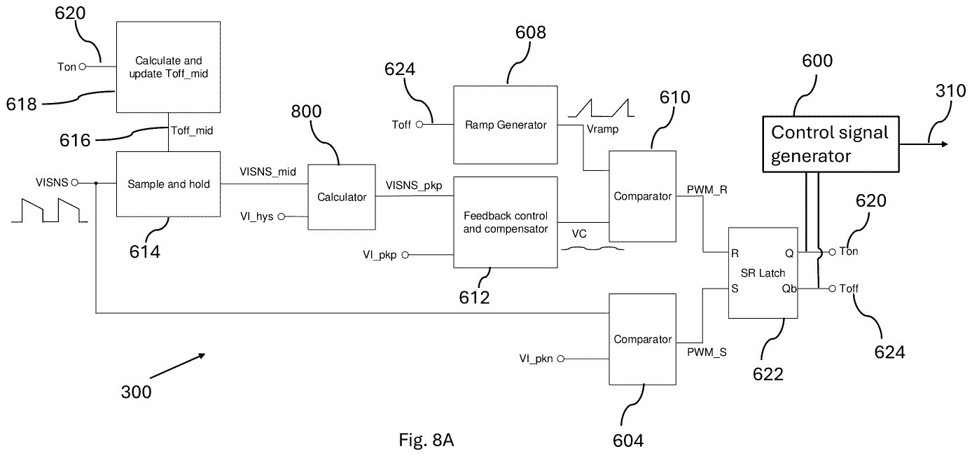

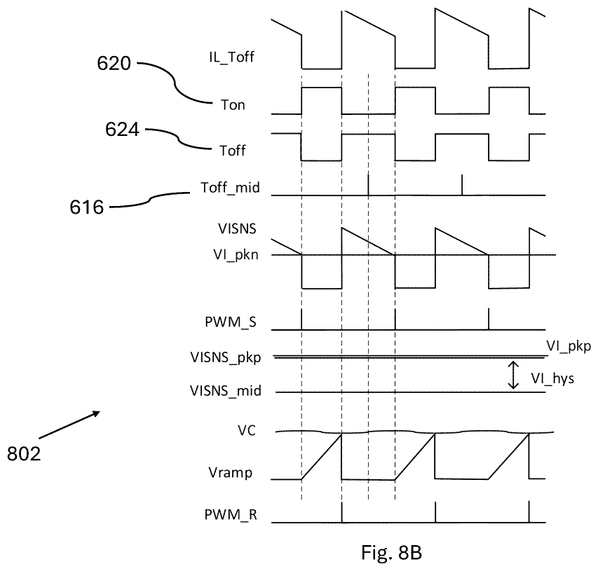

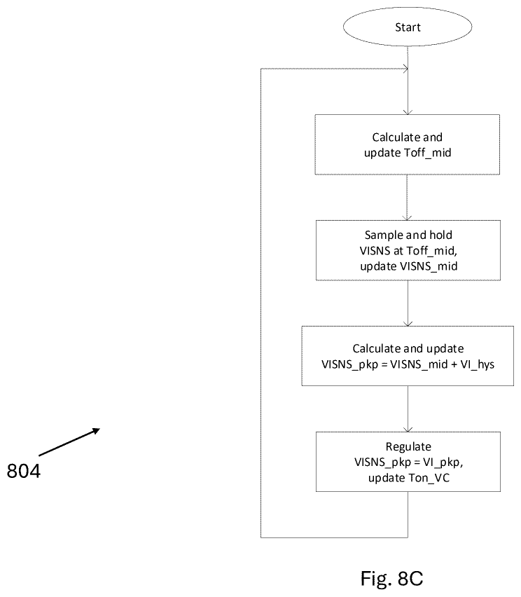

FIG. 8A is a schematic of a specific implementation of the control system 300 that may be implemented with the switching converter 200 of FIG. 2A in accordance with a fifth embodiment of the present disclosure. For example the control system 300 of the present embodiment may be a specific implementation of the control system 300 of FIG. 4A.

In the present embodiment, the control system 300 comprises a calculation unit 800 configured to receive the voltage measurement VISNS_mid as measured at the time step Toff_mid, and calculate a voltage measurement VISNS_pkp using the voltage measurement VISNS_mid and a calculation voltage VI_hys. The compensation circuit 612 is configured to receive the voltage measurement VISNS_pkp and compare the voltage measurement VISNS_pkp with a threshold voltage VI_pkp. The compensation circuit 612 is further configured to compare the voltage measurement VISNS_pkp with the threshold voltage VI_pkp and to generate the threshold duration signal VC based on the comparison between VISNS_pkp and VI_pkp.

FIG. 8B is a timing graph 802 showing waveforms related to a practical implementation of the control system 300 of FIG. 8A. The waveforms shown in the graph 802 are as described previously for FIG. 2B with additional waveforms being as shown in FIG. 8A.

The turn on condition for the switch 304 may be summarised as: when VISNS<VI_pkn, turn on the switch 304. The turn off condition for the switch 304 may be summarised as: when Ton=Ton_VC, turn off switch 304.

FIG. 8C is a flow chart 804 illustrating the operation of the switch 304 of the present embodiment.

In the present embodiment VISNS_pkp is calculated based on VISNS_mid, and may be summarized as follows:
1. Calculate and update Toff_mid.
2. Sample and hold VISNS at Toff_mid, and update VISNS_mid.
3.

$$\begin{matrix}Calculate VISNS\_pkp = VISNS\_mid + Vhys \\ = VISNS\_mid + ( VI\_ref - VI\_pkn ) \\ = VISNS\_mid + ( VISNS\_mid - VI\_pkn ) \\ = VISNS\_mid \times 2 - VI\_pkn\end{matrix}$$

4. Regulate VISNS_pkp=VI_pkp, and update Ton_VC.

In summary, the turn-on timing is determined by the comparator 604 whose inputs are VISNS and VI_pkn. The turn-off timing is determined by the comparator 610 whose inputs are Vramp and VC, while VC is an error signal from VI_pkp and VISNS_pkp, which is calculated by: VISNS_pkp=VISNS_mid+Vhys.

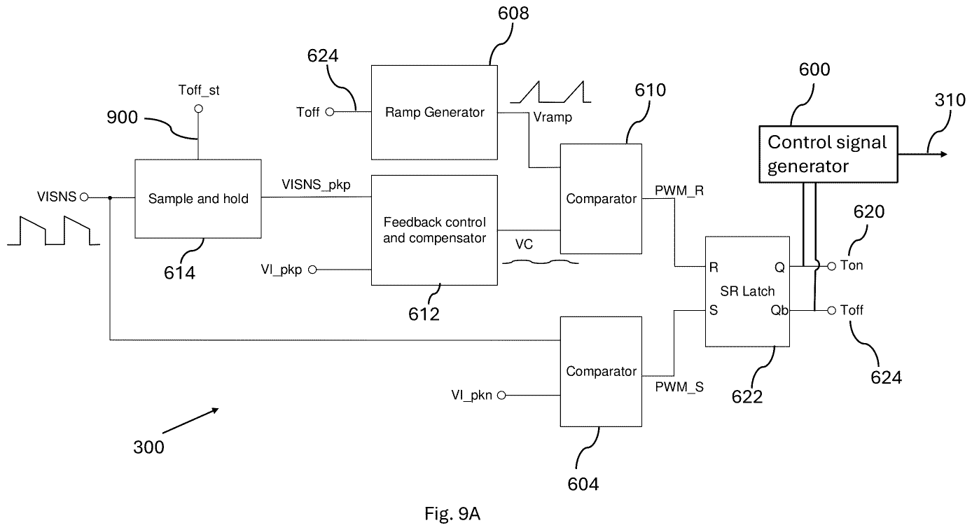

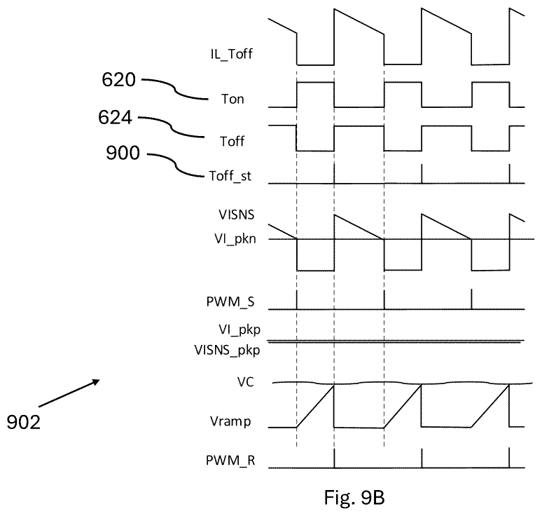

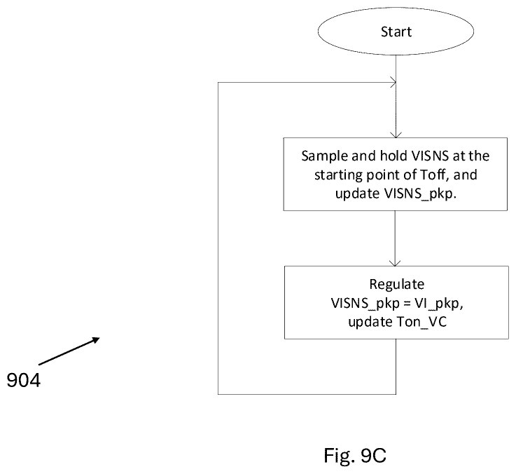

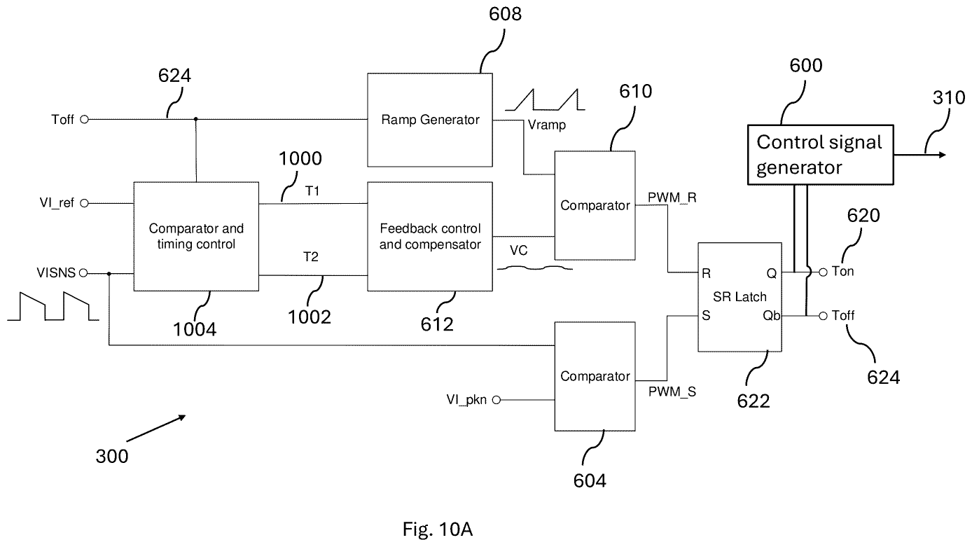

FIG. 9A is a schematic of a specific implementation of the control system 300 that may be implemented with the switching converter 200 of FIG. 2A in accordance with a sixth embodiment of the present disclosure. For example the control system 300 of the present embodiment may be a specific implementation of the control system 300 of FIG. 4A.

In the present embodiment, the sample and hold circuit 614 is configured to receive the sense resistor voltage VISNS and a time step signal 900 that is dependent on a time step Toff_st and provide the voltage measurement VISNS_pkp as acquired by measuring the sense resistor voltage VISNS at the time step Toff_st.

As VISNS_pkp is the peak of VISNS during Toff, the sense resistor voltage VISNS should be sampled immediately after the switch 304 changes to the off state. For example, the time step Toff_st may be within the first 0% to 10% of the off state duration Toff.

In the present embodiment VISNS_pkp is the result of sampling and holding VISNS at the staring time point of Toff. Operation of the circuit may be summarised as follows:
1. Sample and hold VISNS at the starting point of Toff, and update VISNS_pkp.
2. Regulate VISNS_pkp=VI_pkp, and update Ton_VC.

FIG. 9B is a timing graph 902 showing waveforms related to a practical implementation of the control system 300 of FIG. 9A. The waveforms shown in the graph 902 are as described previously for FIG. 2B with additional waveforms being as shown in FIG. 9A.

FIG. 9C is a flow chart 904 illustrating the operation of the switch 304 of the present embodiment.

In summary, the turn-on timing is determined by the comparator 604 whose inputs are VISNS and VI_pkn. The turn-off timing is determined by the comparator 610 whose inputs are Vramp and VC, while VC is an error signal from VI_pkp and VISNS_pkp, which is sampled-and-held VISNS at Toff_st.

In previous embodiments, Ton_VC is generated by regulating VISNS at different timings. The inductor current regulation can also be achieved by regulating the time ratio.

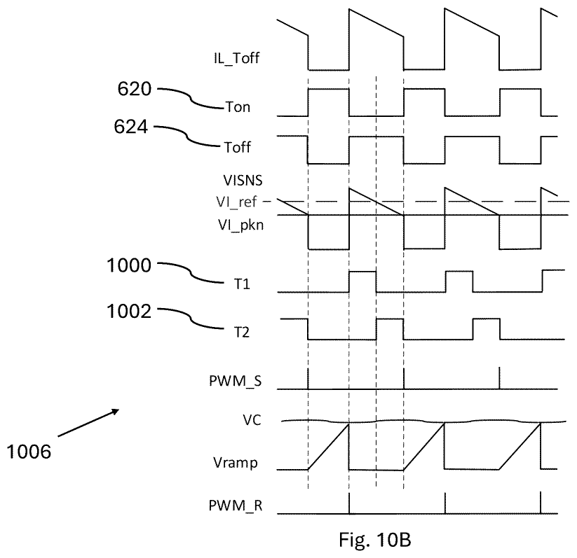

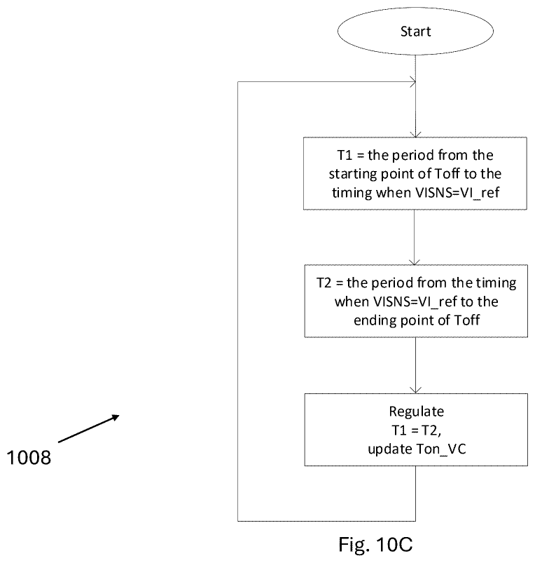

FIG. 10A is a schematic of a specific implementation of the control system 300 that may be implemented with the switching converter 200 of FIG. 2A in accordance with a seventh embodiment of the present disclosure. For example the control system 300 of the present embodiment may be a specific implementation of the control system 300 of FIG. 4A.

In the present embodiment, the compensator circuit 612 is configured to receive a time period signal 1000 comprising information on a time period T1. The time period T1 is a time period from the time when the switch 304 transitions to the off state until the sense resistor voltage VISNS is approximately equal to a threshold voltage VI_ref. The compensator circuit 612 is further configured to receive a time period signal 1002 comprising information on a time period T2. The time period T2 is a time period from the time at which the sense resistor voltage VISNS is approximately equal to the threshold voltage VI_ref to the time at which the switch 304 transitions from the off state to the on state.

The compensator circuit 612 is configured to generate the threshold duration signal VC based on the comparison between the time periods T1 and T2.

The control system 300 may further comprise a comparator and timing control circuit 1004 that is configured to receive the sense resistor voltage VISNS, the threshold voltage VI_ref and the off state timing signal 624, and to generate the time period signals 1000, 1002 using the sense resistor voltage VISNS, the threshold voltage VI_ref and the off state timing signal 624.

FIG. 10B is a timing graph 1006 showing waveforms related to a practical implementation of the control system 300 of FIG. 10A. The waveforms shown in the graph 1002 are as described previously for FIG. 2B with additional waveforms being as shown in FIG. 10A.

FIG. 10C is a flow chart 1008 illustrating the operation of the switch 304 of the present embodiment.

By controlling the valley of VISNS to VI_pkn, the inductor ripple current can be regulated to:

$$IL\_hys = VI\_hys / RISINS \qquad ( 4 )$$

Equation (4) may be achieved by the operation: when VISNS<VI_pkn, turn on the switch 304.

When IL_avg is regulated to VI_ref/RISNS, T1 should be equal to T2. If T1 is not equal to T2, Ton can be modulated to achieve the regulation.

The regulation can be achieved by various implementations, and it will generate a control operation based on Ton and a threshold duration Ton_VC. In a specific embodiment, there may be a counter to implement this functionality. The counter may be a digital or an analog counter. Counting may begin from the timing of the switch SW1 turning on and may continue until the switch SW1 is turned off at Ton_VC. With this control, Ton is equal to Ton_VC.

The turn on condition for the switch 304 may be summarised as: when VISNS<VI_pkn, turn on the switch 304. The turn off condition for the switch 304 may be summarised as: when Ton=Ton_VC, turn off switch 304.

The flow chart 1008 may be summarised as follows:
1. T1=the period from the starting point of Toff to the timing when VISNS=VI_ref.
2. T2=the period from the timing when VISNS=VI_ref to the ending point of Toff.
3. Regulate T1=T2, and update Ton_VC.

In summary, the turn-on timing is determined by the comparator 604 whose inputs are VISNS and VI_pkn. The turn-off timing is determined by the comparator 610 whose inputs are Vramp and VC, while VC is an error signal from T1 and T2.

FIG. 4A shows the control system 300 as may be used with the switching converter 302, where the switching converter 302 is implemented using the switching converter 200 configuration as presented in FIG. 2A, with its associated waveforms shown in FIG. 2B.

The embodiments of the control system 300 as presented in FIG. 6A, FIG. 8A, FIG. 9A and FIG. 10A are example implementations of the control system 300 of FIG. 4A as may be used with the switching converter 200 configuration.

It will be appreciated that further embodiments of the control system 300 as presented in each of FIG. 6A, FIG. 8A, FIG. 9A and FIG. 10A may be configured to function with the switching converter 206 of FIG. 2C.

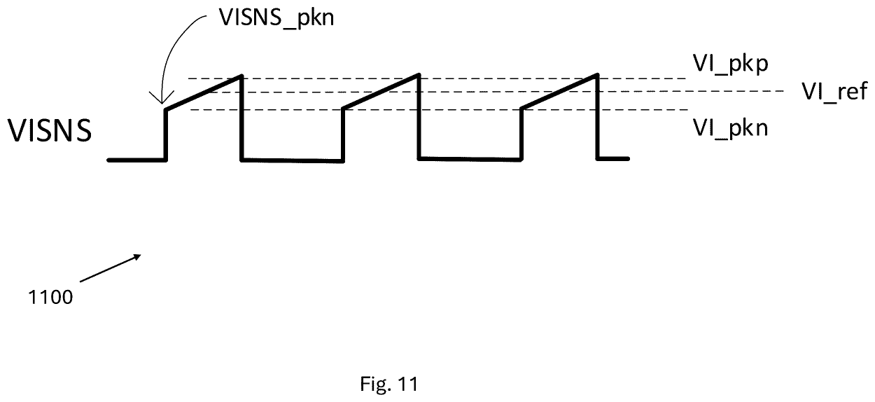

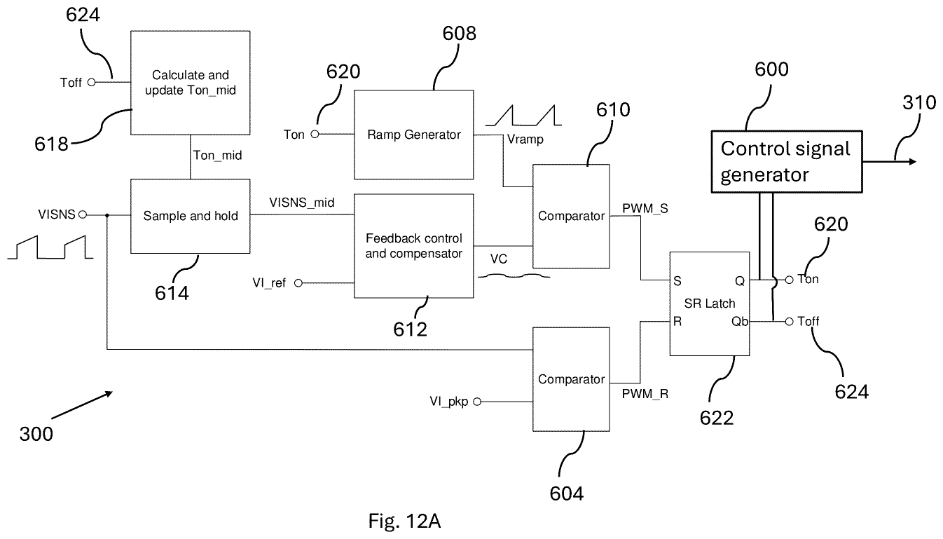

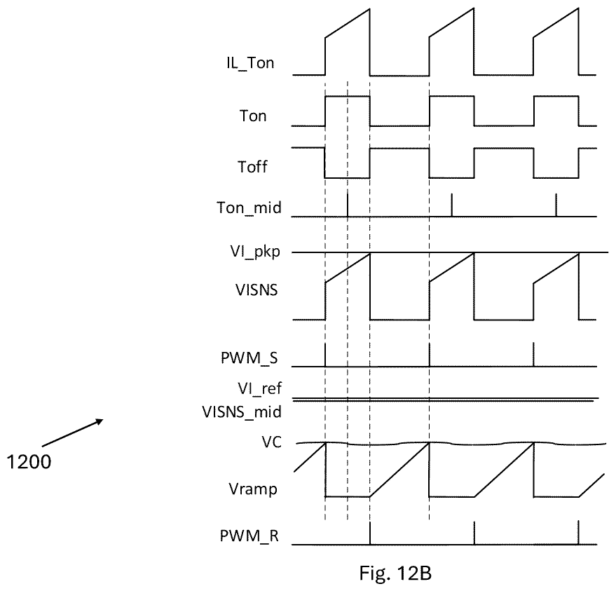

FIG. 11 is a timing graph 1100 showing the relationship between voltages for a practical implementation of the switching converter 206 of FIG. 2C.

The current sense resistor RISNS in FIG. 2C can detect IL_Ton, so:

$$VISNS = IL\_Ton \times RISNS \qquad ( 7 )$$

$$VISNS\_mid + I\_mid \times RISNS \qquad ( 8 )$$

When the inductor operates at CCM, I_mid is equal to the average inductor current IL_avg. Thus, the constant current regulation can be achieved by regulating I_mid, and it can be achieved by regulating VISNS_mid as well.

By controlling the peak of VISNS to VI_pkp, the inductor ripple current can be regulated to:

$$IL\_hys = VI\_hys / RISNS \qquad ( 4 )$$

Equation (4) may be achieved by the operation: when VISNS>VI_pkp, turn off the switch SW1.

By regulating VISNS_mid to VI_ref, or VISNS_pkn to VI_pkn, or T1=T2, the average inductor current can be regulated to:

$$IL\_avg = VI\_ref / RISNS \qquad ( 5 )$$

Equation (5) can be achieved by modulating Toff, which is the off time of the switch SW1.

The regulation can be achieved by various implementations, and it will generate a control operation based on Toff and a threshold duration Toff_VC. In a specific embodiment, there may be a counter to implement this functionality. The counter may be a digital or an analog counter.

Counting may begin from the timing of the switch SW1 turning on and may continue until the switch SW1 is turned off at Toff_VC. With this control, Toff is equal to Toff_VC.

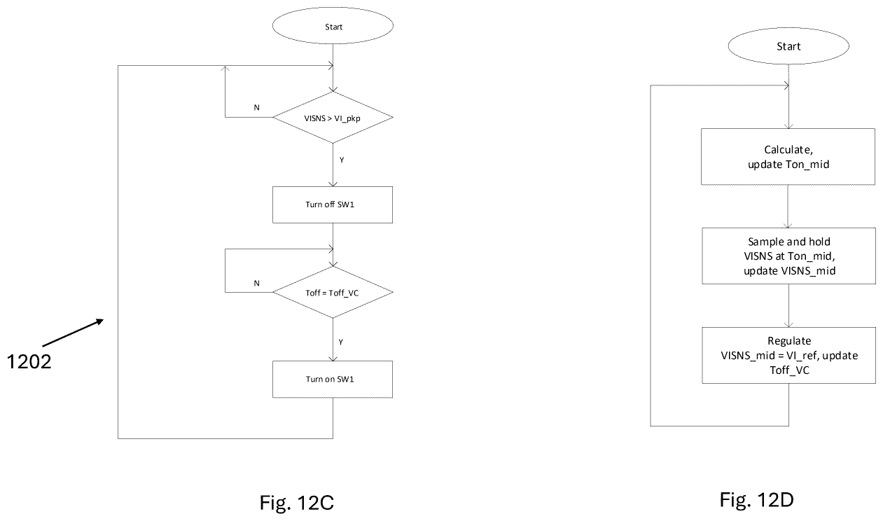

FIG. 12A is a schematic of a specific implementation of the control system 300 that may be implemented with the switching converter 206 of FIG. 2C in accordance with an eighth embodiment of the present disclosure. For example the control system 300 of the present embodiment may be a specific implementation of the control system 300 of FIG. 4B.

FIG. 12B is a timing graph 1200 showing waveforms related to a practical implementation of the control system 300 of FIG. 12A. The waveforms shown in the graph 1200 are as described previously for FIG. 2D with additional waveforms being as shown in FIG. 12A.

FIG. 12C is a flow chart 1202 illustrating the operation of the switch 304 of the present embodiment.

FIG. 12D is a flow chart 1204 showing the regulation of the sense resistor voltage VISNS in the present embodiment.

In summary, the turn-off timing is determined by the comparator 604 whose inputs are VISNS and VI_pkp. The turn-on timing is determined by the comparator 610 whose inputs are Vramp and VC, while VC is an error signal from VI_ref and VISNS_mid.

In summary, the switch operation as illustrated by the flow chart 1202 is as follows:
1. When VISNS>VI_pkp, turn off SW1.
2. When Toff=Toff_VC, turn on SW1.

In summary, the regulation of VISNS_mid as illustrated by the flow chart 1204 is as follows:
1. Calculated and update Ton_mid.
2. Sample and hold VISNS at Ton_mid, and update VISNS_mid.
3. Regulate VISNS_mid=VI_ref, and update Toff_VC.

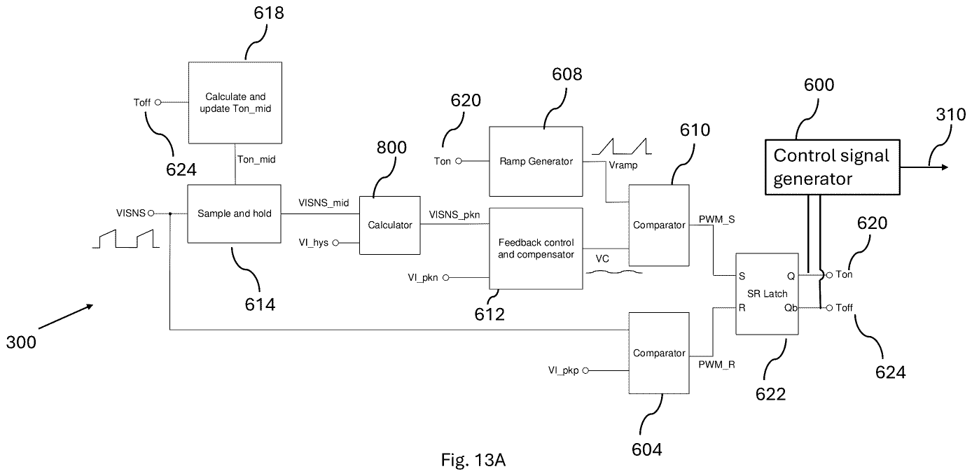

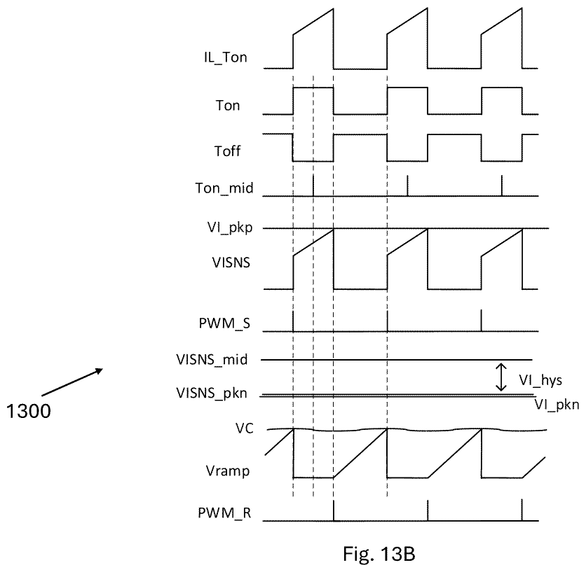

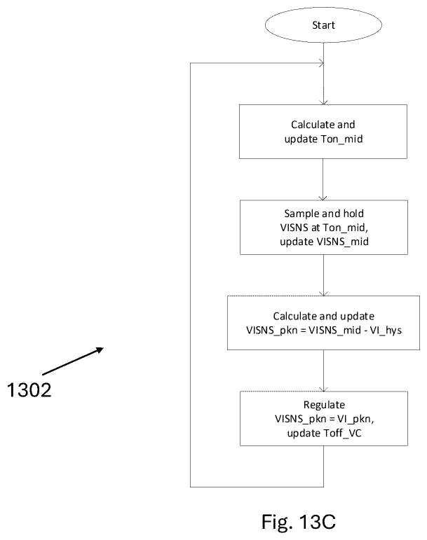

FIG. 13A is a schematic of a specific implementation of the control system 300 that may be implemented with the switching converter 206 of FIG. 2C in accordance with a ninth embodiment of the present disclosure. For example the control system 300 of the present embodiment may be a specific implementation of the control system 300 of FIG. 4B.

FIG. 13B is a timing graph 1300 showing waveforms related to a practical implementation of the control system 300 of FIG. 13A. The waveforms shown in the graph 1300 are as described previously for FIG. 2D with additional waveforms being as shown in FIG. 13A.

FIG. 13C is a flow chart 1302 showing the regulation of the sense resistor voltage VISNS in the present embodiment.

In summary, the turn-off timing is determined by the comparator 604 whose inputs are VISNS and VI_pkp. The turn-on timing is determined by the comparator 610 whose inputs are Vramp and VC, while VC is an error signal from VI_pkn and VISNS_pkn, which is calculated by: VISNS_pkn=VISNS_mid-Vhys.

VISNS_pkn is calculated based on VISNS_mid:
1. Calculated and update Ton_mid.
2. Sample and hold VISNS at Ton_mid, and update VISNS_mid.
3. Calculate VISNS_pkn=VISNS_mid-Vhys
4. Regulate VISNS_pkn=VI_pkn, and update Toff_VC.

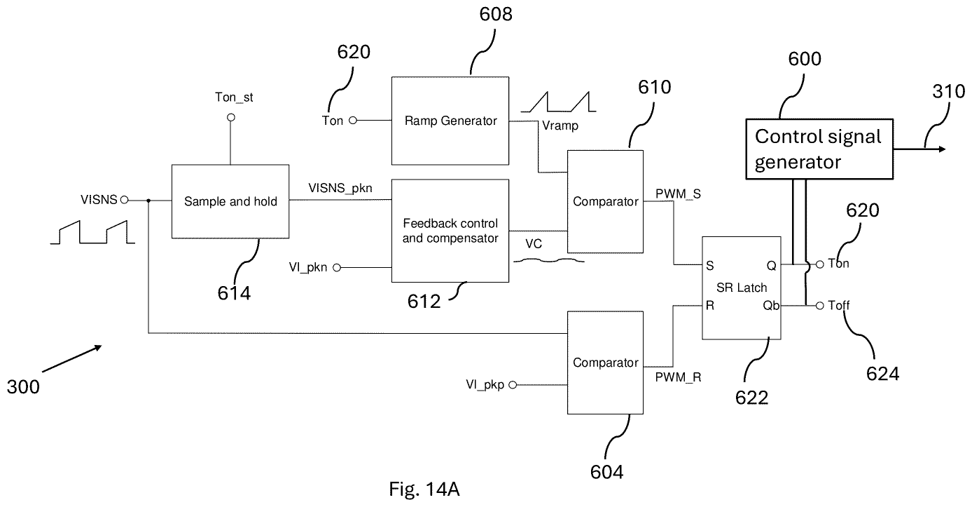

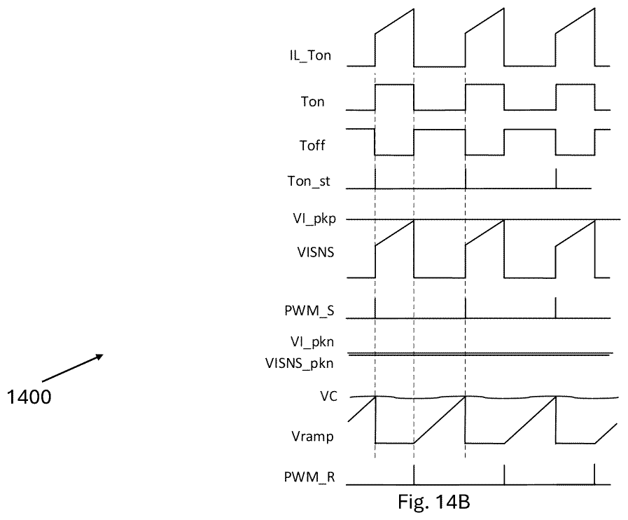

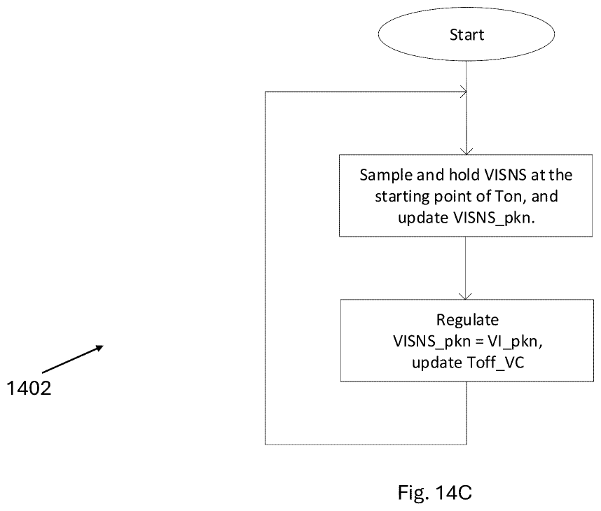

FIG. 14A is a schematic of a specific implementation of the control system 300 that may be implemented with the switching converter 206 of FIG. 2C in accordance with a tenth embodiment of the present disclosure. For example the control system 300 of the present embodiment may be a specific implementation of the control system 300 of FIG. 4B.

FIG. 14B is a timing graph 1400 showing waveforms related to a practical implementation of the control system 300 of FIG. 14A. The waveforms shown in the graph 1400 are as described previously for FIG. 2D with additional waveforms being as shown in FIG. 14A.

FIG. 14C is a flow chart 1402 showing the regulation of the sense resistor voltage VISNS in the present embodiment.

In summary, the turn-off timing is determined by the comparator 604 whose inputs are VISNS and VI_pkp. The turn-on timing is determined by the comparator 610 whose inputs are Vramp and VC, while VC is an error signal from VI_pkn and VISNS_pkn, which is sampled-and-held VISNS at Ton_st.

VISNS_pkn is sample and hold VISNS at the staring time point of Ton:
1. Sample and hold VISNS at the starting point of Ton, and update VISNS_pkn.
2. Regulate VISNS_pkn=VI_pkn, and update Toff_VC.

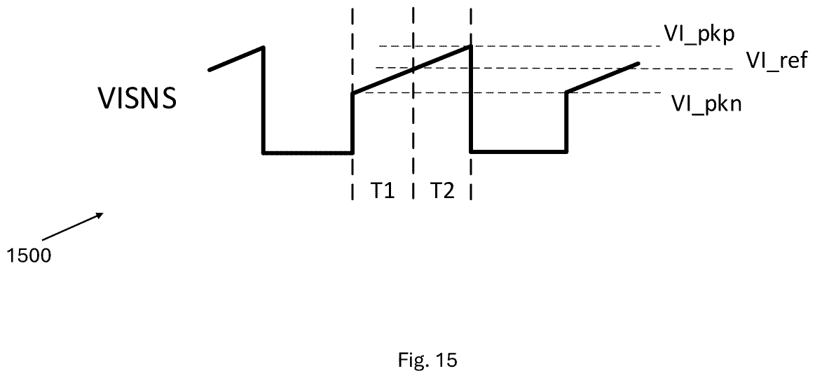

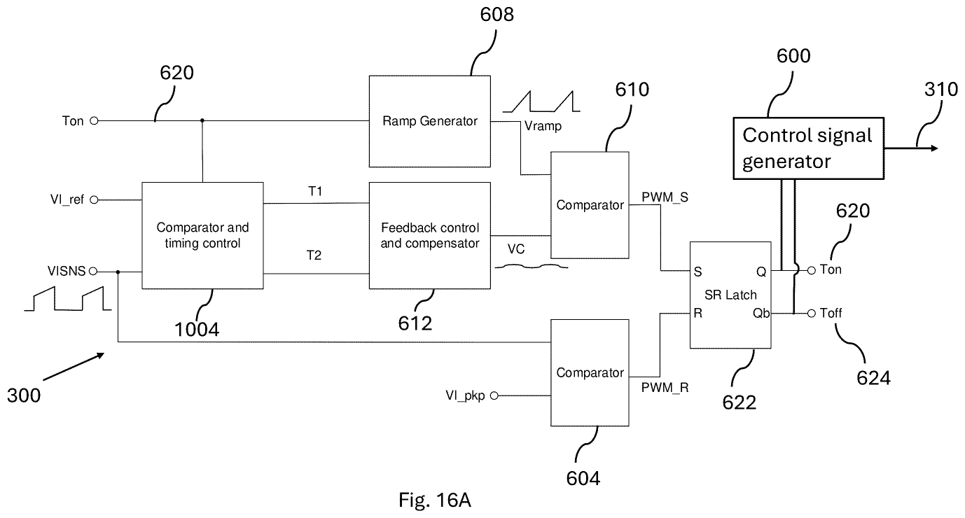

FIG. 15 is a timing graph 1500 showing the relationship between voltages for a practical implementation of the switching converter 206 of FIG. 2C. FIG. 15 shows the conceptual waveforms of VISNS and the regulation target for the time ratio.

T1 is the period from the starting point of Ton to the timing when VISNS=VI_ref. T2 is the period from the timing when VISNS=VI_ref to the ending point of Ton.

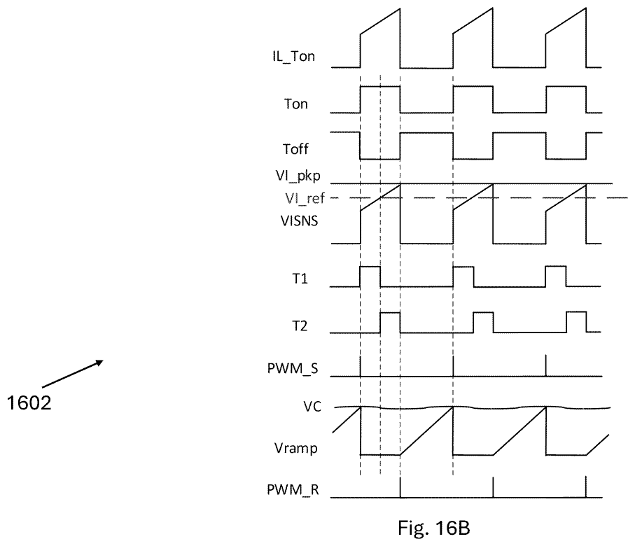

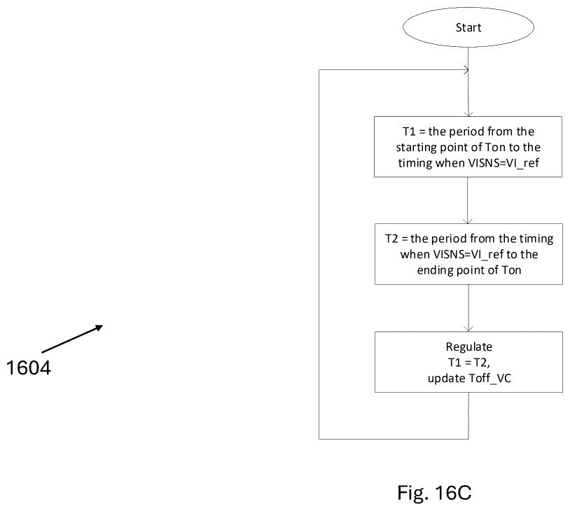

FIG. 16A is a schematic of a specific implementation of the control system 300 that may be implemented with the switching converter 206 of FIG. 2C in accordance with an eleventh embodiment of the present disclosure. For example the control system 300 of the present embodiment may be a specific implementation of the control system 300 of FIG. 4B.

FIG. 16B is a timing graph 1600 showing waveforms related to a practical implementation of the control system 300 of FIG. 16A. The waveforms shown in the graph 1600 are as described previously for FIG. 2D with additional waveforms being as shown in FIG. 16A.

FIG. 16C is a flow chart 1602 showing the regulation of the sense resistor voltage VISNS in the present embodiment.

In summary, the turn-off timing is determined by the comparator 604 whose inputs are VISNS and VI_pkp. The turn-on timing is determined by the comparator 610 whose inputs are Vramp and VC, while VC is an error signal from T1 and T2.

The flow chart 1602 may be summarized as follows:
1. T1=the period from the starting point of Ton to the timing when VISNS=VI_ref.
2. T2=the period from the timing when VISNS=VI_ref to the ending point of Ton.
3. Regulate T1=T2, and update Toff_VC.

Since the sum of the turn-on and turn-off duty ratios equals 100% when the converter operates in CCM, Ton and Toff are inverse logic to each other. It will be appreciated that in the block diagrams, for example: FIG. 6A, 8A, 9A, 10A, 12A, 13A, 14A, 16A, Ton and Toff are interchangeable. It will be appreciated that the markings on the Figures are examples are not the only way to implement the control system.

With regards to the control system 300 and switching converter 302 of FIG. 4A, the specific embodiments described herein provide the following control methodologies for regulating the average VISNS during Toff:
(1) Regulate the VISNS at the midpoint of Toff, referred to as VISNS_mid in FIG. 2B.
(2) Regulate the peak of the VISNS. Since the valley of the VISNS is equal to the low threshold, regulating the peak will control the average value.
(3) Regulate the VISNS at different timing points during Toff. Ideally, the slope of inductor current is consistent. Thus, by regulating one point of VISNS while the valley of the VISNS is equals to the low threshold, the average current is regulated.
(4) Regulate the time ratio as halfway. The time period from the MOSFET turned off to the timing when VISNS is equal to the average current should be the same as the time period from the timing when VISNS is equal to the average current to MOSFET turned on.
(5) Regulate the time ratio to different proportions. Ideally, the slope of inductor current is consistent. Thus, the average current can be controlled as long as the timing ratio corresponds to the current ratio.

It will be appreciated that further methods for regulating the average VISNS during Toff are possible, in accordance with the understanding of the skilled person.

With regards to the control system 300 and switching converter 302 of FIG. 4B, the specific embodiments described herein provide the following control methodologies for regulating the average VISNS during Ton:
(1) Regulate the VISNS at the midpoint of Ton, referred to as VISNS_mid in FIG. 2D.
(2) Regulate the valley of the VISNS. Since the peak of the VISNS is equal to the high threshold, regulating the valley will control the average value.
(3) Regulate the VISNS at different timing points during Ton. Ideally, the slope of inductor current is consistent. Thus, by regulating one point of VISNS while the peak of the VISNS is equal to the high threshold, the average current is regulated.
(4) Regulate the time ratio as halfway. The time period from the MOSFET turned on to the timing when VISNS is equal to the average current should be the same as the time period from the timing when VISNS is equal to the average current to MOSFET turned off.
(5) Regulate the time ratio to different proportions. Ideally, the slope of inductor current is consistent. Thus, the average current can be controlled as long as the timing ratio corresponds to the current ratio.

It will be appreciated that further methods for regulating the average VISNS during Toff are possible, in accordance with the understanding of the skilled person.

Known systems have the following disadvantages:
1. The power loss on the current sensing resistor is high.
2. The output negative terminal is not at the same node as the ground.

Embodiments of the present disclosure overcome the disadvantages of the known systems by providing the following advantages:
1. The current flowing through the current sensing resistor is portion of the inductor current, so its power loss is lower.
2. The output negative terminal is the ground, making it suitable for parallel connection of multi-channel applications.

In summary, embodiments of the present disclosure achieve the inductor current regulation with lower power loss and connect the output negative terminal to ground.

Embodiments of the present disclosure may control the valley of the voltage across the sensing resistor and regulate the voltage across the sensing resistor at specific timing during the switching period.

Embodiments of the control system 300 of the present disclosure may provide current regulation for the switching converter 302. As discussed previously many applications require a regulated current source. Battery charging is one application that requires a constant current source. Another large application is LED lighting, as the light output of LED devices is variable based on forward current. Embodiments of the control system 300 of the present disclosure can therefore provide improvements in systems that require current regulation.

It will be appreciated that common reference numerals and variables between figures represent common features in accordance with the understanding of the skilled person.

Various improvements and modifications may be made to the above without departing from the scope of the disclosure.

1. A control system for a switching converter for receiving an input voltage and generating an output voltage, the switching converter comprising:
a first switch configured to be switchable between a first state and a second state;
a sense device; and
an energy storage element;
wherein the control system is configured to:
receive a sense device voltage from the sense device; and
provide a control signal to control the first switch to:
switch the first switch from the first state to the second state based on the sense device voltage as detected whilst the first switch is in the first state; and
switch the first switch from the second state to the first state based on the sense device voltage as detected whilst the first switch is in the first state.

2. The control system of claim 1, wherein the sense device comprises a sense resistive element.

3. The control system of claim 2, wherein the control system is configured to detect the sense device voltage across the sense resistive element, thereby receiving the sense device voltage from the sense device.

4. The control system of claim 3, wherein the switching converter comprises:
a first pass device coupled to the first switch at a switching node;
wherein:
the sense resistive element is coupled in series with the first switch and the first pass device; and
the energy storage element is coupled to the switching node.

5. The control system of claim 1, wherein the switching converter is a buck converter, a boost converter, a buck-boost converter, or a Totem-Pole PFC boost converter.

6. The control system of claim 1, wherein:
the first state is an on state and the second state is an off state; or
the first state is the off state and the second state is the on state.

7. The control system of claim 1, further comprising a control signal generator configured to generate the control signal.

8. The control system of claim 7, further comprising:
a first comparator configured to:
receive the sense device voltage during the first state; and
compare the sense device voltage with a first reference voltage;
wherein the control signal generator is configured to:
generate the control signal to switch the first switch from the first state to the second state based on the comparison of the sense device voltage with the first reference voltage.

9. The control system of claim 8, wherein the control signal generator is configured to:
generate the control signal to switch the first switch from the second state to the first state when a second state duration is approximately equal to a first threshold duration, the first threshold duration being dependent on the sense device voltage during the first state.

10. The control system of claim 9, further comprising:
a ramp generator configured to generate a ramp voltage signal that increases whilst the first switch is in the second state;
a second comparator configured to:
receive the ramp voltage signal, the ramp voltage signal being indicative of the second state duration;
receive a first threshold duration signal that is dependent on the sense device voltage during the first state, and is indicative of the first threshold duration; and
compare the ramp voltage signal with the first threshold duration signal;
wherein the control signal generator is configured to:
generate the control signal to switch the first switch from the second state to the first state when the ramp voltage signal is approximately equal to the first threshold duration signal, thereby generating the control signal to switch the first switch from the second state to the first state when the second state duration is approximately equal to the first threshold duration.

11. The control system of claim 9, further comprising a compensator circuit configured to:
receive a first voltage measurement of the sense device voltage as measured at a first time step during the first state;
compare the first voltage measurement with a first threshold voltage; and
generate the first threshold duration signal based on the comparison between the first voltage measurement and the first threshold voltage.

12. The control system of claim 11, further comprising a sample and hold circuit configured to:
receive the sense device voltage;
receive a first time step signal that is dependent on the first time step; and
provide the first voltage measurement as acquired by measuring the sense device voltage at the first time step.

13. The control system of claim 12, further comprising a time determination unit configured to:
receive a second state timing signal that is in a low state when the first switch is in the first state and is in a high state when the first switch is in the second state; and
generate the first time step signal using the second state timing signal.

14. The control system of claim 11, wherein:
the first time step is at a mid point between the beginning and end of a first state duration, the first state duration being the time over which the first switch is in the first state; or
the first time step is within the first 0% to 10% of the first state duration.

15. The control system of claim 9, further comprising:
a calculation unit configured to:
receive a first voltage measurement of the sense device voltage as measured at a first time step during the first state; and
calculate a second voltage measurement using the first voltage measurement and a first calculation voltage; and
a compensator circuit configured to:
receive the second voltage measurement;
compare the second voltage measurement with a first threshold voltage; and
generate the first threshold duration signal based on the comparison between the second voltage measurement and the first threshold voltage.

16. The control system of claim 15, further comprising a sample and hold circuit configured to:
receive the sense device voltage;
receive a first time step signal that is dependent on the first time step; and
provide the first voltage measurement as acquired by measuring the sense device voltage at the first time step.

17. The control system of claim 16, further comprising a time determination unit configured to:
receive a second state timing signal that is in a low state when the first switch is in the first state and is in a high state when the first switch is in the second state; and
generate the first time step signal using the second state timing signal.

18. The control system of claim 9, further comprising a compensator circuit configured to:
receive a first time period signal comprising information on a first time period from a time at which the first switch transitions to the first state until the sense device voltage is approximately equal to a second threshold voltage; and
receive a second time period signal comprising information on a second time period from a time at which the sense device voltage is approximately equal to the second threshold voltage to a time at which the first switch transitions from the first state.

19. The control system of claim 18, further comprising a comparator and timing control circuit configured to:
receive the sense device voltage;
receive the second threshold voltage;
receive a first state timing signal that is in a high state when the first switch is in the first state and is in a low state when the first switch is in the second state; and
generate the first time period signal and the second time period signal using the sense device voltage, the first threshold voltage and the first state timing signal.

20. The control system of claim 10, wherein:
the first comparator is configured to provide a first comparator output that is dependent on the comparison between sense device voltage and the first reference voltage;
the second comparator is configured to provide a second comparator output that is dependent on the comparison between the ramp voltage signal and the first threshold duration signal;
the control system comprises a latch circuit configured to:
receive the first comparator output at a set terminal;
receive the second comparator output at a reset terminal;
provide a second state timing signal that is in a low state when the first switch is in the first state and is in a high state when the first switch is in the second state, at a non-inverting output; and
provide a first state timing signal that is in a high state when the first switch is in the first state and is in a low state when the first switch is in the second state, at an inverting input;
the control signal generator is configured to:
receive one or both of the first and second state timing signals; and
generate the control signal using one or both of the first and second state timing signals.

21. An apparatus comprising a control system and a switching converter for receiving an input voltage and generating an output voltage, the switching converter comprising:
a first switch configured to be switchable between a first state and a second state;
a sense device; and
an energy storage element;
wherein the control system is configured to:
receive a sense device voltage from the sense device; and
provide a control signal to control the first switch to:
switch the first switch from the first state to the second state based on the sense device voltage as detected whilst the first switch is in the first state; and
switch the first switch from the second state to the first state based on the sense device voltage as detected whilst the first switch is in the first state.

22. A method of controlling a switching converter for receiving an input voltage and generating an output voltage using a control system,
the switching converter comprising:
a first switch configured to be switchable between a first state and a second state;
a sense device; and
an energy storage element;
the method comprises:
receiving, using the control system a sense device voltage from the sense device; and
providing, from the control system, a control signal to control the first switch to:
switch the first switch from the first state to the second state based on the sense device voltage as detected whilst the first switch is in the first state; and
switch the first switch from the second state to the first state based on the sense device voltage as detected whilst the first switch is in the first state.
